(19) United States
(12) Patent Application Publication
(10) Pub. No.: US 2026/0283901 A1
(43) Pub. Date: Sep. 24, 2026

(54) COMPRESSION DEPTH FEEDBACK AND ADJUSTMENT

(71) Applicant: Stryker Corporation, Portage, MI (US)

(72) Inventors: Kristian Solem, Trelleborg (SE); Fred W. Chapman, Newcastle, WA (US); Tyson G. Taylor, Bothell, WA (US)

(73) Assignee: Stryker Corporation, Portage, MI (US)

(21) Appl. No.: 19/573,248

(22) Filed: Mar. 20, 2026

Related U.S. Application Data
(60) Provisional application No. 63/775,923, filed on Mar. 21, 2025.

(51) Int. Cl. A61H 31/00

(52) U.S. Cl. CPC A61H 31/005; A61H 31/006; A61H 31/008; A61H 2201/10; A61H 2201/5046

(57) ABSTRACT

CPR systems and/or CPR devices that are configured to dynamically increase, and/or cause output of a feedback signal(s) to increase, a compression depth during a CPR treatment are disclosed. The dynamic adjustment to deeper compressions can treat conditions such as pulseless electrical activity (PEA) and refractory ventricular fibrillation (VF). An example mechanical chest compression device includes a processor(s) and a chest compressing mechanism configured to be disposed on a chest of a subject and to administer chest compressions to the subject. The processor(s) is configured to receive an indication that the subject has a condition that may benefit from deeper compressions, such as PEA or refractory VF, and, in response to receiving the indication that the subject has the condition, cause the chest compressing mechanism to increase a current target compression depth to an increased target compression depth at which future chest compressions are to be administered to the subject.

### CROSS-REFERENCE TO RELATED APPLICATION

This application claims the benefit of U.S. Provisional Application No. 63/775,923, titled “COMPRESSION DEPTH FEEDBACK AND ADJUSTMENT” and filed on Mar. 21, 2025, which is incorporated by reference herein in its entirety.

### BACKGROUND

During cardiac arrest, when a subject's heart stops beating or beats too ineffectively to circulate blood to the brain and other vital organs, cardiopulmonary resuscitation (CPR) can be an effective treatment that saves the life of the subject, if performed properly. CPR involves administering repeated chest compressions to the chest of the subject, which causes blood to circulate through the body of the subject. Historically, CPR has been performed manually by a rescuer placing their hands on the chest of the subject and repeatedly applying a downward force to the chest. However, the efficacy of manual CPR is dependent upon rescuers being trained to administer high quality CPR.

To help ensure that CPR is administered properly on a more consistent basis, and to alleviate some of the burden on rescuers at a rescue scene, various CPR systems have been developed. One example of an existing CPR system is a mechanical chest compression device (also known as a “mechanical CPR device”) that administers automated chest compressions to a subject. Two types of mechanical chest compression devices in use today include piston-based devices, which utilize a piston to compress the subject's chest, and vest-based devices, which utilize a load-distributing band to compress the subject's chest. Another example of a CPR system is a CPR feedback system, which may utilize a device placed on the subject's chest to monitor the chest compressions that a rescuer is manually administering to the subject, and to facilitate the provisioning of real-time feedback to the rescuer to adjust their technique, as needed.

### BRIEF DESCRIPTION OF THE DRAWINGS

FIG. 1 illustrates an environment including an example mechanical chest compression device that is configured to administer a CPR treatment to a subject. FIG. 1 also illustrates components that are configured to dynamically increase a compression depth for administering deeper chest compressions to the subject in response to a determination that the subject has a condition that may benefit from deeper compressions, such as pulseless electrical activity (PEA), refractory ventricular fibrillation (VF), recurrent VF, or asystole.

FIG. 2 illustrates an environment including an example CPR feedback system that is configured to provide feedback for a rescuer to administer deeper chest compressions to the subject in response to a determination that the subject has a condition that may benefit from deeper compressions, such as PEA, refractory VF, recurrent VF, or asystole.

FIG. 3 illustrates the example mechanical chest compression device depicted in FIG. 1, FIG. 3 depicting various example components of the mechanical chest compression device to, among other things, determine a chest size of the subject.

FIG. 4 illustrates two compression and decompression profiles (or, “waveforms”), one waveform exhibiting a shallower compression depth, and the other waveform exhibiting a deeper compression depth.

FIG. 5 illustrates an example process for dynamically increasing a compression depth of automated chest compressions administered by a mechanical chest compression device in response to a determination that the subject has a condition that may benefit from deeper compressions, such as PEA, refractory VF, recurrent VF, or asystole.

FIG. 6 illustrates an example process for dynamically increasing a compression depth of automated chest compressions administered by a mechanical chest compression device in response to a determination that the subject has a condition that may benefit from deeper compressions, such as PEA, refractory VF, recurrent VF, or asystole, and in response to a determination that the chest size of the subject satisfies a threshold size.

FIG. 7 illustrates an example process for evaluating, in response to a determination that the subject has a condition that may benefit from deeper compressions, such as PEA, refractory VF, recurrent VF, or asystole, a compression depth of chest compressions that are being manually administered to a subject to determine whether to output feedback for the rescuer to increase the compression depth.

FIG. 8 illustrates an example external defibrillator configured to perform various functions described herein.

FIG. 9 illustrates an example mechanical chest compression device configured to perform various functions described herein.

### DETAILED DESCRIPTION

Various implementations described herein relate to dynamically increasing a chest compression depth during a CPR treatment. In some examples, implementations include CPR systems and/or CPR devices configured to increase the chest compression depth, or to recommend increases in the chest compression depth. Various implementations can be utilized to treat conditions that may benefit from deeper compressions, such as PEA, refractory VF, recurrent VF, and asystole. As used herein, “compression depth” means a distance that a point on a chest of a subject travels in a downward direction (towards the subject) during a chest compression. Existing mechanical chest compression devices are configured to administer automated chest compressions at compression depths (and compression rates) consistent with CPR guidelines. Similarly, existing CPR feedback systems are configured to provide feedback to a rescuer indicating whether an applied compression depth (and optionally, compression rate) is within CPR guidelines so that the rescuer can adjust their technique, as needed. However, for certain conditions, chest compressions administered in accordance with CPR guidelines are not deep enough for effective treatment of the condition.

About 75% of initial heart rhythms are non-shockable (i.e., not treatable by administration of an electrical shock). PEA is one example of a non-shockable, but non-perfusing, heart rhythm, and asystole is another example of a non-shockable heart rhythm. The survival rate of a PEA patient is much lower than the survival rate of a VF patient. For example, compared to a witnessed VF patient, the survival rate of a PEA patient is about 10 times lower. The survival rate of an asystole patient is even lower than the survival rate of a PEA patient. The survival rate of a refractory VF patient is also much lower than for the average VF patient. While high-quality CPR (e.g., chest compressions administered at a depth, rate, and position within CPR guidelines) is oftentimes sufficient to help a subject in cardiac arrest recover, it is sometimes ineffective for treating subjects with certain conditions, such as PEA, refractory VF, recurrent VF, or asystole. One reason for this is that chest compressions administered at a depth that is within current CPR guidelines may not generate sufficient blood flow to help the subject's heart recover to a state where it can maintain a pulse. For such subjects, deeper chest compressions, such as chest compressions administered at a depth that is outside of current CPR guidelines (e.g., a compression depth greater than 6 centimeters (cm)), may be at least part of a strategy for increasing blood flow to help the subject fully recover.

Implementations of the present disclosure address these and other problems through CPR systems and/or CPR devices that are configured to dynamically increase, and/or cause output of a feedback signal(s) to increase, a compression depth during a CPR treatment in response to a determination that the subject has a condition that may benefit from deeper compressions, such as PEA, refractory VF, recurrent VF, and asystole. An example mechanical chest compression device configured to implement the techniques described herein includes a processor(s) and a chest compressing mechanism configured to be disposed on a chest of a subject and to administer chest compressions to the subject. The processor(s) of the mechanical chest compression device is configured to receive an indication that the subject has a condition that may benefit from deeper chest compressions (e.g., PEA, refractory VF, recurrent VF, asystole, etc.), and in response to receiving the indication that the subject has the condition (e.g., PEA, refractory VF, recurrent VF, asystole, etc.), the processor(s) is configured to cause the chest compressing mechanism to increase a current target compression depth to an increased target compression depth at which future chest compressions are to be administered to the subject.

To illustrate, consider an example where a subject in cardiac arrest suddenly collapses, and a rescuer arrives at the scene to secure a mechanical chest compression device around the subject. Upon activating the mechanical chest compression device, the mechanical chest compression device may administer automated chest compressions to the subject at a first target compression depth. During this CPR treatment, the subject may already be experiencing, be identified as having, or develop a condition, such as PEA, refractory VF (e.g., after administering an electrical shock to the subject with a defibrillator, the heart of the subject might remain in VF), recurrent VF, or asystole. The processor(s) of the mechanical chest compression device, upon receiving an indication (e.g., from the defibrillator) that the subject has the condition (e.g., refractory VF, etc.), may cause the chest compressing mechanism of the mechanical chest compression device to administer subsequent chest compressions to the subject at a second target compression depth greater than the first target compression depth. By dynamically increasing the compression depth during a CPR session, the subject's condition may be resolved. For example, the standard compression depth may have generated inadequate blood flow, but the blood flow may be increased by administering deeper compressions. The increased blood flow may help to restore cardiac mechanical function and/or reduce the heart's propensity to be in VF.

An example CPR feedback system configured to implement the techniques described herein includes a processor(s) and a sensor(s) configured to sense a parameter(s) associated with a subject as a rescuer is manually administering chest compressions to the subject. The processor(s) of the CPR feedback system is configured to determine that the subject has a condition (e.g., PEA, refractory VF, recurrent VF, asystole, etc.) that may benefit from chest compressions deeper than a compression depth that is recommended in CPR guidelines, and to determine, by analyzing the parameter(s) sensed by the sensor(s), that the rescuer is manually administering the chest compressions to the subject at a first compression depth. In response to determining that the subject has the condition (e.g., PEA, refractory VF, recurrent VF, asystole, etc.), and in response to determining that the first compression depth is less than a target compression depth for treating the condition, the processor(s) is configured to cause a signal(s) to be output as feedback for the rescuer to administer future chest compressions to the subject at the target compression depth.

To illustrate, consider an example where a subject in cardiac arrest collapses, and a rescuer arrives at the scene to begin manually administering chest compressions to the subject with the aid of a CPR feedback device equipped with a sensor(s) to sense a parameter(s) (e.g., a chest compression depth parameter) during CPR. During this manual CPR treatment, the subject may already be experiencing, be identified as having, or develop a condition, such as PEA, refractory VF, recurrent VF, or asystole. In an example of refractory VF, for instance, a defibrillator may be used to administer an electrical shock to the subject, and after doing so, the heart of the subject might remain in VF. The processor(s) of the CPR feedback system (e.g., a processor(s) of the defibrillator, or a processor(s) of the CPR feedback device), upon determining that the subject has the condition (e.g., refractory VF, etc.), determines, by analyzing the parameter(s) (e.g., the chest compression depth parameter) sensed by the sensor(s), that the rescuer is manually administering the chest compressions to the subject at a first compression depth that is too shallow (e.g., the first compression depth is less than a target compression depth for treating the condition of the subject). Accordingly, in response to determining that the subject has the condition (e.g., PEA, refractory VF, recurrent VF, asystole, etc.), and in response to determining that the first compression depth is less than the target compression depth for treating the condition, the processor(s) may cause a signal(s) to be output as feedback for the rescuer to administer future chest compressions to the subject at the target compression depth, and/or to administer future chest compressions that are deeper than the first compression depth to which the rescuer is currently administering the chest compressions. For instance, the signal(s) may be a visual signal displayed on a display of the defibrillator to “compress deeper.” By providing real-time feedback to the rescuer to dynamically increase the compression depth during a CPR session, the subject's condition may be resolved if the rescuer adjusts their technique in accordance with the feedback. For example, the standard compression depth may have generated inadequate blood flow, but the blood flow may be increased by administering deeper compressions. The increased blood flow may help to restore cardiac mechanical function and/or reduce the heart's propensity to be in VF.

In some examples, after dynamically increasing, or providing feedback to a rescuer to dynamically increase, the compression depth, the processor(s) is configured to continue monitoring the condition to determine whether the subject no longer has the condition, and, upon making such a determination, the mechanical chest compression device may revert to a previous (e.g., original, default, etc.) compression depth at which to administer future chest compressions, and/or the processor(s) may cause an output device to output a signal(s) as feedback for the rescuer to decrease the compression depth (or otherwise revert to a previous compression depth that is shallower than the increased compression depth that was used to treat the condition). In various implementations, a CPR system and/or a CPR device that is configured to dynamically increase, and/or cause output of a feedback signal(s) to increase, a compression depth during a CPR treatment will improve the quality of the CPR treatment administered to at least a population of subjects experiencing conditions that may benefit from deeper compressions, such as PEA, refractory VF, recurrent VF, or asystole. CPR that is administered to this population with deeper chest compressions may increase their survival rate. Moreover, with the techniques, devices, and systems described herein, rescuers can trust CPR systems to administer high quality CPR and/or to provide reliable feedback that can be trusted for administering effective CPR.

In some examples, a chest size of a subject who is receiving the CPR treatment is taken into consideration before administering deeper chest compressions (or providing feedback to do so), which mitigates injury to a population of subjects with smaller chest sizes. For example, it may be more likely to injure a relatively small subject, such as pediatric patient, by increasing the compression depth beyond the recommended compression depth in current CPR guidelines, as compared to the risk of injury to a relatively large subject, such as an adult subject with a sufficiently large chest size. Accordingly, in these examples, the processor(s) of the CPR system and/or CPR device may receive an indication that a size of the chest of the subject satisfies a threshold size, and in response to receiving this indication, the processor(s) may dynamically increase, and/or cause output of a feedback signal(s) to increase, a compression depth during the CPR treatment to treat a condition, such as PEA, refractory VF, recurrent VF, or asystole, with deeper compressions. By factoring chest size into the determination to dynamically increase the compression depth, instances of injury can be mitigated by ensuring that the chest size of the subject is large enough to benefit from the deeper compressions at a reduced risk of injury from the deeper compressions. Chest size of the subject may be determined in various ways, as described in more detail below.

Various implementations will now be described with reference to the accompanying figures.

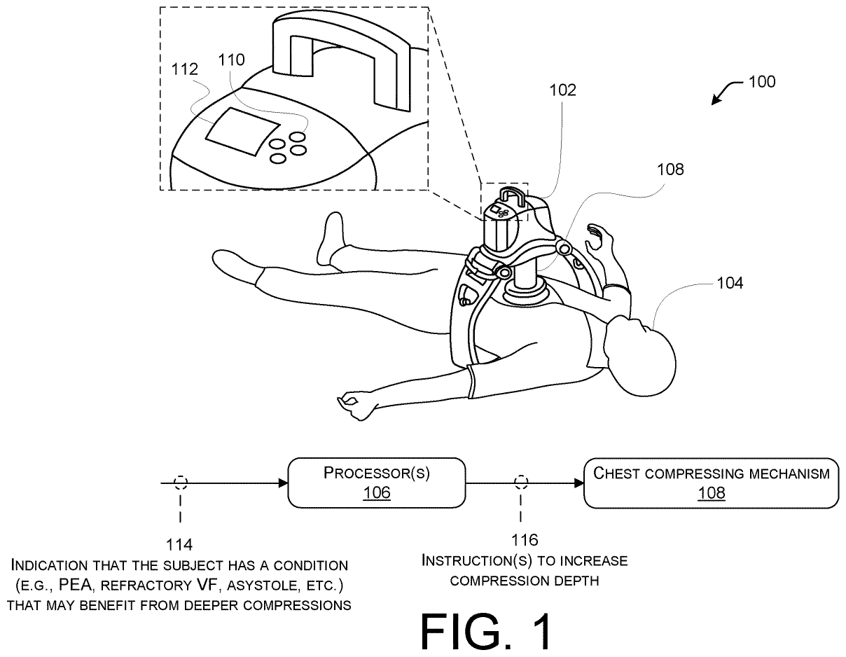

FIG. 1 illustrates an environment 100 including an example mechanical chest compression device 102 that is configured to administer a CPR treatment to a subject 104. In various cases, the environment 100 is in an out-of-hospital environment. For example, the subject 104 may have experienced a medical emergency in a non-hospital, public space, such as a library, airport terminal, school, or office building. In some cases, the subject 104 has collapsed or otherwise lost consciousness within the environment 100. In some examples, the subject 104 has experienced one or more other types of symptoms associated with a serious health condition (e.g., cardiac arrest). As a result, a bystander may have contacted emergency services personnel in order to assist the subject 104 and to transport the subject 104 to a clinical environment, if necessary.

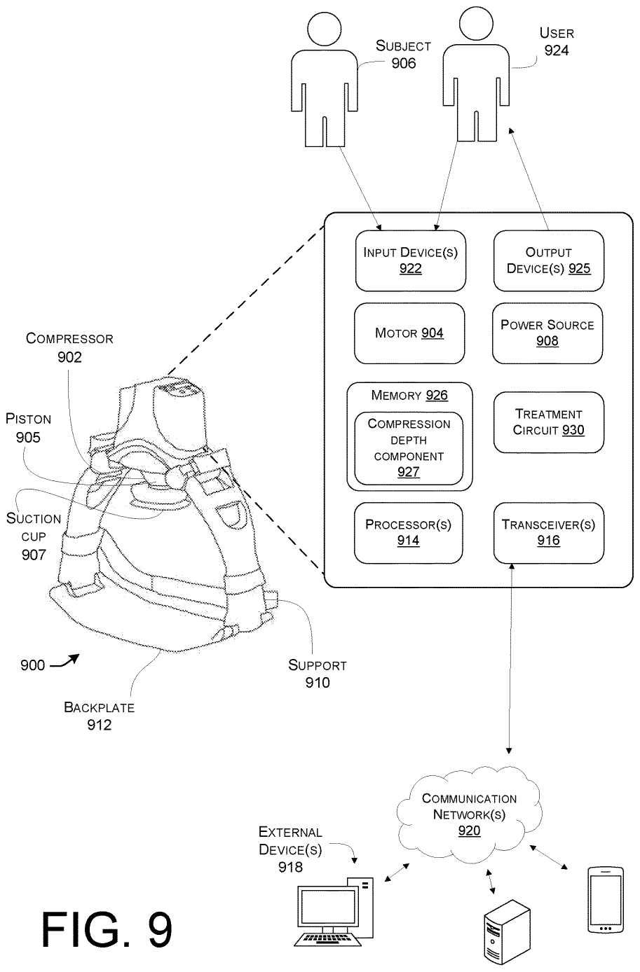

In various cases, a rescuer (not shown in FIG. 1) arrives at the rescue scene, secures the mechanical chest compression device 102 around the subject 104 (e.g., around a thorax thereof), and begins operating, and/or initiates autonomous operation of, the mechanical chest compression device 102. For example, the rescuer may provide input to the mechanical chest compression device 102 to set one or more chest compression parameters (e.g., compression rate, compression depth, etc.), and/or to start CPR treatment (e.g., autonomous chest compressions) via the mechanical chest compression device 102. Various example components of the mechanical chest compression device 102 shown in FIG. 1 are described in more detail below with respect to FIG. 9. In some examples, the mechanical chest compression device 102 includes a processor(s) 106 and a chest compressing mechanism 108. In some examples, the mechanical chest compression device 102 includes an input device(s) 110 and/or an output device(s) 112. The chest compressing mechanism 108 is configured to be disposed on a chest of the subject 104 and to move for administering chest compressions to the subject 104. The example mechanical chest compression device 102 shown in FIG. 1 is a piston-based device. Accordingly, the chest compressing mechanism 108 illustrated in FIG. 1 is in the form of a piston, the piston being movable bidirectionally between various positions relative to the frame of the mechanical chest compression device 102 and/or relative to the subject 104 (e.g., the chest compressing mechanism 108 is configured to move up and down relative to the chest of the subject 104 when the subject 104 is lying on their back in a horizontal orientation). It is to be appreciated, however, that other types of mechanical chest compression devices may implement the techniques described herein, such as vest-based devices where the chest compressing mechanism includes a load-distributing band disposed around the thorax of the subject 104.

The processor(s) 106 of the mechanical chest compression device 102 is configured to cause the chest compressing mechanism 108 to move, thereby administering chest compressions to the subject 104 over a series of compression-decompression cycles. In some examples, the processor(s) 106 is configured to execute computer-executable instructions stored in memory of the mechanical chest compression device 102 to control the movement of the chest compressing mechanism 108, as described herein. In some examples, the processor(s) 106 is configured to control the movement of the chest compressing mechanism in accordance with one or more settings of the mechanical chest compression device 102, which may be adjusted by a user (e.g., a rescuer at the rescue scene). Additionally, or alternatively, such settings may be initialized automatically (without user intervention) by the mechanical chest compression device 102 at a time at which the mechanical chest compression device 102 is initialized (e.g., powered on) and/or adjusted automatically (without user intervention) on-the-fly during CPR treatment. The settings of the mechanical chest compression device 102 may relate to various chest compression parameters, such as compression rate, compression depth, compression force, compression velocity, compression acceleration, one or more hold periods during the compression and/or decompression phases, the duty cycle of the mechanical chest compression device 102, active decompression height, compression position on the chest, and/or the like. In some examples, the chest compressing mechanism 108 may be controlled by the processor(s) 106 to administer chest compressions to the subject 104 at a first target compression depth. This first target compression depth may correspond to a default compression depth, a compression depth parameter set by the rescuer via user input at the beginning of the CPR treatment or in the midst of the CPR treatment, and/or the like. In some examples, the first target compression depth is within a first target value range (e.g., a range of 5 cm to 6 cm, a range of 5 cm to 5.5 cm, a range of 5.5 cm to 6 cm, etc.), which may be in-line with CPR guidelines.

As depicted in FIG. 1, the processor(s) 106 of the mechanical chest compression device 102 may receive an indication 114 that the subject 104 has a condition that may benefit from, among other types of treatment, deeper chest compressions (e.g., compressions that are deeper than the chest compressions currently being administered at the first target compression depth). Examples of such a condition include PEA, refractory VF, recurrent VF, fine VF, asystole, low blood pressure (e.g., pressure pulses that are less than a threshold, systolic blood pressure below a threshold, diastolic blood pressure below a threshold, instantaneous blood pressure below a threshold), low blood flow (e.g., volumetric blood flow through at least one blood vessel that is less than a threshold), low partial pressure of CO₂ (e.g., EtCO₂ below a threshold) in the airway of subject 104, low blood oxygenation (e.g., a peripheral oxygenation, a cerebral oxygenation, or a pulse oxygenation measurement that is below a threshold), and/or the like. Although the examples described herein are focused on treating conditions like PEA, refractory VF, recurrent VF, or asystole with deeper chest compressions, it is to be appreciated that other conditions that may benefit from shallower chest compressions may be detected and treated by dynamically decreasing the compression depth. In other words, although many of the examples described herein pertain to increasing the compression depth to administer deeper chest compressions, it is also contemplated that compression depth may be adjusted in the opposite direction (e.g., by decreasing the compression depth) to administer shallower chest compressions. Dynamically decreasing the compression depth to a shallower compression depth may be beneficial for subjects who are starting to regain consciousness, for subjects with nonrefractory VF, or for subjects who also receive cardiac support in another way (e.g., with an Impella® device, an extracorporeal membrane oxygenation (ECMO) device, an extracorporeal CPR (eCPR) device, a resuscitative endovascular balloon occlusion of the aorta (REBOA) device, or a similar device or form of treatment. In some examples, a predefined set of one or more conditions that may benefit from deeper (or shallower) compressions is stored in memory accessible to the processor(s) 106, and the processor(s) 106 may receive the indication 114 in a scenario where a detected condition of the subject 104 is (e.g., matches) one of the conditions in the predefined set of one or more conditions.

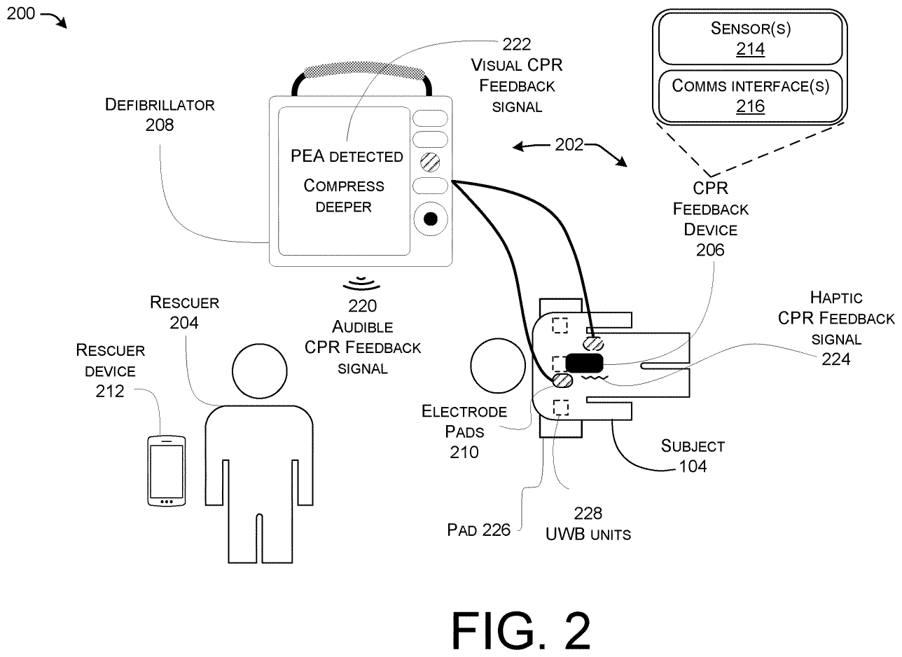

The indication 114 may be received in various ways and/or from various devices that are external to the mechanical chest compression device 102 and communicatively coupled thereto, and/or from components of the mechanical chest compression device 102 itself, and/or from user input received via the input device(s) 110 of the mechanical chest compression device 102. For instance, the indication 114 may be received from a monitor-defibrillator (not shown in FIG. 1) communicatively coupled with the mechanical chest compression device 102. For instance, FIG. 2 depicts a defibrillator 208, which can be communicatively coupled with the mechanical chest compression device 102 depicted in FIG. 1, in some examples. Such a monitor-defibrillator may be equipped with electrode pads adhered to the skin on the chest of the subject 104, as well as a detection circuit configured to detect an electrocardiogram (ECG) of the subject 104 based on an electrical signal output by the heart of the subject 104 and detected by the electrode pads. In this example, PEA, asystole, recurrent VF, and/or refractory VF may be detectable, at least in part, from the ECG of the subject 104. In some examples, one or more sensors are applied to the body of the subject 104 and communicatively coupled to the monitor-defibrillator and/or to the mechanical chest compression device 102, the sensor(s) configured to generate electrical signals that are indicative of various physiological parameters of the subject 104. Such physiological parameter(s) may include a blood pressure parameter(s) (e.g., detected using a blood pressure sensor(s) attached to the subject 104), a blood flow parameter(s), a blood oxygenation parameter(s), airway parameter(s) (e.g., capnograph, end-tidal carbon dioxide (EtCO₂)), an ultrasound parameter(s) (e.g., a blood velocity derived using a Doppler probe), a photoplethysmography (PPG) parameter, an audible heart sound parameter(s), and/or other physiological parameters associated with the subject 104. In some examples, such sensors may be communicatively coupled to the mechanical chest compression device 102 directly, and the indication 114 may be received without reliance on a monitor-defibrillator (e.g., if a monitor-defibrillator is unavailable at the rescue scene).

In some examples, the input device(s) 110 of the mechanical chest compression device 102 is configured to receive user input. In some examples, the input device(s) 110 include one or more buttons that are depressible or otherwise actuatable (e.g., by touching the buttons), a touch-sensitive display, and/or the like. In some examples, the input device(s) 110 include a microphone(s) to receive voice-based user input (e.g., voice commands), which may allow for hands-free operation of the mechanical chest compression device 102. In some examples, the mechanical chest compression device 102 is operable in multiple different modes (e.g., modes of operation or operating modes), and the rescuer may provide user input via the input device(s) 110 to change the operating mode of the mechanical chest compression device 102. In these examples, the respective operating modes may correspond to respective compression depths that are different from one another. For example, the mechanical chest compression device 102 may be configured to operate in a first mode (e.g., a “normal compression” mode) where the chest compressing mechanism 108 administers the chest compressions at a first target compression depth, which may be in-line with CPR guidelines, as described above. Additionally, the mechanical chest compression device 102 may be configured to operate in a second mode (e.g., an “enhanced compression” mode) where the chest compressing mechanism 108 administers the chest compressions at a second target compression depth greater than the first target compression depth, which may be outside of a range of compression depths recommended in CPR guidelines. In other words, when the mechanical chest compression device 102 switches to operation in the enhanced compression mode, the chest compressing mechanism 108 may be controlled to administer deeper chest compressions than before, and potentially at a compression depth that is deeper than the compression depth recommended in CPR guidelines. In some examples, the rescuer may provide user input to switch between the multiple operating modes of the mechanical chest compression device 102. Additionally, or alternatively, the processor(s) 106 may be configured to cause the mechanical chest compression device 102 to switch the operating mode automatically (e.g., in response to receiving the indication 114 without any user intervention), or semi-automatically (e.g., in response to receiving the indication 114 and prompting a rescuer for confirmatory user input to proceed with deeper chest compressions).

In some examples, the input device(s) 110 receives user input to change an operating mode of the mechanical chest compression device 102 (e.g., from a current operating mode to the enhanced compression mode), and the indication 114 is received in response to receiving such user input via the input device(s) 110. For example, if the rescuer has discovered that the subject 104 has a condition, such as PEA, refractory VF, recurrent VF, or asystole, the rescuer may decide to switch the mechanical chest compression device 102 to the enhanced compression mode to increase the depth of the chest compressions in an effort to increase blood flow through the administration of deeper automated chest compressions. In these examples, the rescuer may be an experienced rescuer and may know, from reading the output on the display of a monitor-defibrillator being used to monitor and/or treat the subject 104, how to detect PEA, refractory VF, recurrent VF, and/or asystole. Additionally, or alternatively, the display of the monitor-defibrillator may output a visual indication that the subject 104 has such a condition (e.g., PEA, refractory VF, recurrent VF, asystole, etc.), and the rescuer may respond by switching the operating mode of the mechanical chest compression device 102 to start administering deeper chest compressions than before. In some examples, the input device(s) 110 receives user input confirming that the subject 104 has the condition (e.g., PEA, refractory VF, recurrent VF, asystole, etc.), and the indication 114 is received in response to receiving such user input via the input device(s) 110. In some examples, the output device(s) 112 (e.g., a display(s)) outputs (e.g., displays) a prompt for the rescuer to confirm that the subject 104 has the condition (e.g., PEA, refractory VF, recurrent VF, asystole, etc.), and the rescuer can confirm that the subject 104 has the condition by providing confirmatory user input (e.g., selecting “Yes” on a touch-sensitive display, selecting a button, etc.) in response to the prompt output via the output device(s) 112. In this example, the processor(s) 106 may receive the indication 114 after the rescuer confirms that the subject 104 has the condition, which may have been detected using the aforementioned sensor(s) and/or the monitor-defibrillator itself.

FIG. 1 also illustrates that the processor(s) 106 is configured to dynamically increase (or otherwise change) the compression depth at which future chest compressions are to be administered to the subject 104. That is, the mechanical chest compression device 102 is, in some examples, configured to dynamically increase the compression depth in response to the indication 114 received by the processor(s) 106. For example, as the mechanical chest compression device 102 is administering automated chest compressions, the processor(s) 106 may receive the indication 114, and, in response, the processor(s) 106 provides an instruction(s) 116 that causes the chest compressing mechanism 108 to increase the compression depth (e.g., by traveling a farther distance for each future chest compression that is administered to the subject 104). In some examples, the instruction(s) 116 causes future chest compressions to be administered at a specific target compression depth that is greater than a current target compression depth, such as a second target compression depth that is greater than 6 cm. In some examples, the instruction(s) 116 causes the compression depth to increase by a predefined amount (e.g., by instructing the chest compressing mechanism 108 to administer future chest compressions at a compression depth that is 0.5 cm deeper than the current target compression depth). In some examples, the second target compression depth is selected based at least in part on the chest size of the subject 104. Example techniques and components for determining the chest size of the subject 104 are described in more detail below. For example, the processor(s) 106 may provide a first instruction(s) 116 to increase the compression depth by a first amount for a pediatric subject 104, the processor(s) 106 may provide a second instruction(s) 116 to increase the compression depth by a second amount greater than the first amount for an adult subject 104, and so on. In some examples, the processor(s) 106 may be configured to select a second target compression depth from a plurality of target compression depths that are respectively associated with a plurality of chest sizes and/or patient types. For example, a smaller chest size may be associated with a relatively shallower target compression depth, and a larger chest size may be associated with a relatively deeper target compression depth such that the processor(s) 106 may select the appropriate target compression depth that is customized the subject 104.

In some examples, after dynamically increasing the compression depth, the processor(s) 106 is configured to continue monitoring the condition to determine whether the subject no longer has the condition that may benefit from deeper compressions. Upon making such a determination, the mechanical chest compression device 102 may revert to a previous (e.g., original, default, etc.) compression depth at which to administer future chest compressions. In this manner, the mechanical chest compression device 102 may be configured to continuously and dynamically adjust the compression depth in either direction (e.g., by increasing the compression depth or by decreasing the compression depth), depending on the current condition of the subject and whether deeper compressions may be beneficial to improve the outcome of the subject 104. As mentioned above, administering deeper chest compressions may be at least part of a strategy for increasing blood flow to help the subject 104 fully recover, and it is to be appreciated that other types of treatment besides deeper compressions may be administered to help the subject 104 fully recover, and those other types of treatments may be administered before, simultaneously with, and/or after the administration of deeper chest compressions. In one example, a subject 104 with refractory VF may also benefit from antiarrhythmic therapy. As another example, a subject 104 with bradycardia or some types of asystole may benefit from external pacing therapy. Accordingly, deeper compressions may be augmented with these and other types of treatment, or vice versa.

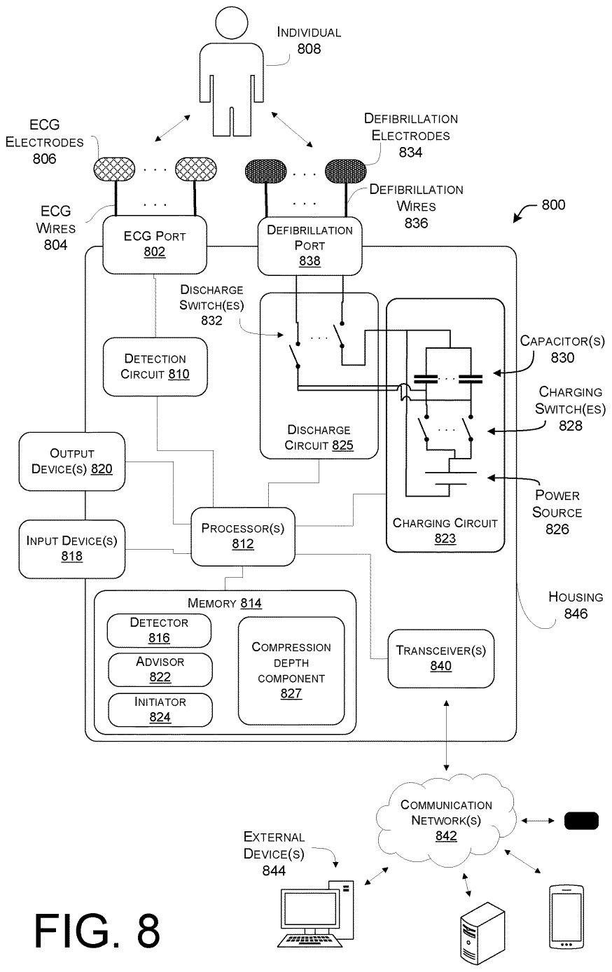

FIG. 2 illustrates an environment 200 including an example CPR feedback system 202 that is configured to provide feedback for a rescuer 204 to administer deeper chest compressions to the subject 104 in response to a determination that the subject 104 has a condition that may benefit from deeper compressions, such as PEA, refractory VF, recurrent VF, or asystole. In some examples, the CPR feedback system 202 includes a CPR feedback device 206 and a defibrillator 208. Various example components of the defibrillator 208 shown in FIG. 2 are described in more detail below with respect to FIG. 8. In some examples, the rescuer 204 operates the defibrillator 208 to monitor and potentially treat the subject 104. In some examples, the defibrillator 208 is a monitor-defibrillator, an automated external defibrillator (AED), or other defibrillator device. In some examples, the defibrillator 208 is designed for operation by users without specialized medical knowledge. In some examples, the rescuer 204 has specific medical expertise. For instance, the rescuer 204 is an emergency medical services (EMS) professional, a physician, a nurse, or some other individual with specific medical training.

In some examples, the defibrillator 208 instructs the rescuer 204 to apply electrode pads 210 to the skin of the subject 104. For example, the electrode pads 210 may be adhered to skin on the chest of the subject 104. In some examples, the CPR feedback device 206 is integrated into the electrode pads 210. For example, the electrode pads 210 may be mechanically coupled to the CPR feedback device 206 and used as an all-in-one accessory of the defibrillator 208. In some examples, the CPR feedback device 206 is separate from the electrode pads 210 (e.g., a standalone CPR feedback device 206).

The defibrillator 208 includes one or more detection circuits (See FIG. 8), or measurement circuit(s), configured to detect one or more physiological parameters of the subject 104. The detection circuit(s), for instance, is configured to be connected to one or more sensors that are applied to the body of the subject 104. The sensor(s), for instance, is configured to generate electrical signals that are indicative of the physiological parameter(s) of the subject 104. The detection circuit(s) may infer the physiological parameter(s) based on the electrical signals generated by the sensor(s).

In some examples, the electrode pads 210 include electrodes that are configured to detect an electrical signal output by the heart of the subject 104 over time. A detection circuit in the defibrillator 208, for instance, is configured to detect an ECG of the subject 104 based on the electrical signal detected by the electrode pads 210.

In some examples, the CPR feedback system 202 includes the CPR feedback device 206 and a rescuer device 212. In some examples, the rescuer device 212 is a mobile phone, a tablet, a laptop computer, a smart watch, a head-mounted display (HMD), or any other suitable user device operable by the rescuer 204. In some examples, the CPR feedback system 202 includes the CPR feedback device 206, the defibrillator 208, and the rescuer device 212.

As shown in FIG. 2, the CPR feedback device 206 may include one or more sensors 214 and one or more communication interfaces 216. The communication interface(s) 216 may include one or more wired interfaces, one or more wireless interfaces, or a combination thereof. The communication interface(s) 216 configure the CPR feedback device 206 to communicate with (e.g., send signals, data, etc. to, and receive signals, data, etc. from) another device(s), such as the defibrillator 208 and/or the rescuer device 212. In some examples, the CPR feedback device 206 and the defibrillator 208 are configured to be wirelessly paired. Once paired, the CPR feedback device 206 is configured to communicate wirelessly with the defibrillator 208 over at least one wireless channel via the communication interface(s) 216. Additionally, or alternatively, the CPR feedback device 206 is configured to couple with the defibrillator 208 via one or more cables or wires, such as the cables that connect the electrode pads 210 to the defibrillator 208, and/or a separate cable(s) or wire(s). In this latter example, the CPR feedback device 206 is configured to communicate with the defibrillator 208 over the cable(s) or wire(s) via the communication interface(s) 216. In some examples, the CPR feedback device 206 and the rescuer device 212 are configured to be wirelessly paired or coupled via one or cables or wires in a similar fashion.

Various mechanisms can be utilized to pair the CPR feedback device 206 with the defibrillator 208 and/or the rescuer device 212. For example, automated pairing may involve the exchange of data and/or pairing requests/responses between the CPR feedback device 206 and the defibrillator 208 and/or between the CPR feedback device 206 and the rescuer device 212. As another example, the defibrillator 208 may receive an input signal from an operator (e.g., the rescuer 204) that selects the CPR feedback device 206 as a device to pair with the defibrillator 208, or vice versa. Similarly, the rescuer device 212 may allow an operator (e.g., the rescuer 204) to select the CPR feedback device 206 as a device to pair with the rescuer device 212, such as via an application (e.g., a CPR feedback application) executing on the rescuer device 212. In some cases, the defibrillator 208 and/or the rescuer device 212 detects an alternative signal (e.g., a flashing light pattern) from the CPR feedback device 206 that is indicated in a pairing request. In some cases, the defibrillator 208 and/or the rescuer device 212 is paired with the CPR feedback device 206 based, at least in part, on signaling to and/or from an intermediary device (not illustrated). In a particular example, two or more devices can be brought into proximity to (e.g., into contact with) each other in order to facilitating pairing (e.g., the defibrillator 208 with the CPR feedback device 206). For example, a “tap-to-pair” functionality may allow a user to bring the CPR feedback device 206 (or a component thereof) into close proximity to (e.g., into contact with) the defibrillator 208 (or a component thereof), or vice versa, and a short-range wireless protocol, such as BLUETOOTH™, near-field communication (NFC), or the like, may be used to detect that the defibrillator 208 and CPR feedback device 206 are within a threshold distance of each other, and, in response, the defibrillator 208 and the CPR feedback device 206 may be paired. In some cases, an intermediary device (e.g., the rescuer device 212) may be brought into close proximity to (e.g., into contact with) the defibrillator 208 and/or the CPR feedback device 206 (e.g., by touching the intermediary device to both the defibrillator 208 and the CPR feedback device 206 sequentially), and a short-range wireless protocol may be used to detect these proximity events involving the intermediary device, and, in response, the defibrillator 208 and the CPR feedback device 206 may be paired.

In some examples, sensor(s) are connected to the defibrillator 208 to detect one or more physiological parameters of the subject 104. In some examples, such physiological parameter(s) may include a blood pressure parameter(s), a blood flow parameter(s), a blood oxygenation parameter(s), an EtCO₂ parameter(s), an ultrasound parameter(s), a PPG parameter, an audible heart sound parameter(s), and/or other physiological parameters associated with the subject 104. The sensor(s) 214 of the CPR feedback device 206 is configured to sense one or more parameters associated with the subject 104 and/or with the CPR treatment (e.g., chest compressions) that the rescuer 204 is manually administering to the subject 104. For example, the sensor(s) 214 may include one or more accelerometers, inertial measurement unit(s) (IMU(s)), gyroscopes, compasses, pressure sensor(s) (e.g., force sensing resistor(s) (FSR(s))), proximity sensor(s) (e.g., capacitive sensor(s)), auscultation device(s)/sensor(s), microphone(s), and/or other sensors that are configured to sense one or more parameter(s) associated with the subject 104 as the subject 104 is receiving CPR treatment. The parameter(s) sensed by the sensor(s) 214 can include a compression parameter(s) (e.g., compression rate, compression depth, compression force, compression velocity, compression acceleration, hand position on the chest, etc.), an audible heart sound parameter(s) (e.g., the opening and/or closing of valves of the heart of the subject 104, such as the aortic valve, the pulmonary valve, the mitral valve, etc.).

A processor(s) of the CPR feedback system 202 (e.g., a processor(s) of the defibrillator 208 (See FIG. 8), a processor(s) of the rescuer device 212, a processor(s) of the CPR feedback device 206, etc.) is configured to determine whether the subject 104 has a condition that may benefit from deeper compressions, such as PEA, refractory VF, recurrent VF, asystole, low blood pressure (e.g., pressure pulses that are less than a threshold), low blood flow (e.g., blood flow that is less than a threshold), and/or the like. The processor(s) can make this determination in various ways and/or using various devices and/or various sensors described herein. For example, as mentioned above, PEA, asystole, recurrent VF, and/or refractory VF may be detectable, at least in part, from the ECG of the subject 104, as detected by a detection circuit in the defibrillator 208 based on the electrical signal detected by the electrode pads 210. In some examples, low blood pressure and/or low blood flow may be detectable, at least in part, from pressure pulses and/or blood flow parameters sensed by one or more sensors applied to the body of the subject 104 and communicatively coupled to the defibrillator 208 and/or to the rescuer device 212. More generally, a condition of the subject 104 that may benefit from deeper (or shallower) chest compressions may be determined by the processor(s) of the CPR feedback system 202 based on data and/or electrical signals indicative of various physiological parameters of the subject 104. In some examples, a predefined set of one or more conditions that may benefit from deeper (or shallower) compressions is stored in memory accessible to the processor(s) of the CPR feedback system 202, and the processor(s) may determine that the subject has a condition that may benefit from deeper (or shallower) chest compressions in a scenario where a detected condition of the subject 104 is (e.g., matches) one of the conditions in the predefined set of one or more conditions.

In some examples, if the processor(s) of the CPR feedback system 202 determines that the subject 104 has a condition that may benefit from deeper compressions, the processor(s) analyzes one or more of parameter(s) associated with the subject 104 and sensed by a sensor(s) (e.g., a sensor(s) applied to the body of the subject 104 and connected to the defibrillator 208, the sensor(s) 214 of the CPR feedback device 206, etc.) to determine a compression depth to which the rescuer 204 is manually administering chest compressions to the subject 104. The processor(s) may then determine whether the current compression depth is “deep enough” to treat the determined condition of the subject 104, such as PEA, refractory VF, recurrent VF, or asystole. For example, the processor(s) may be configured to access, from memory of any of the devices of the CPR system 202 and/or from a remote storage device accessible to the processor(s) over a wide-area network (e.g., the Internet), data indicating a target compression depth for treating the condition of the subject 104. In some examples, this data may indicate a plurality of target compression depths for treating a plurality of conditions that may benefit from deeper chest compressions. For example, the data may indicate a first target compression depth for treating PEA, a second target compression depth for treating refractory VF, a third target compression depth for treating low blood pressure, a fourth target compression depth for treating low blood flow, a fifth target compression depth for treating asystole, a sixth target compression depth for treating recurrent VF, and so on. Accordingly, the processor(s) may be configured to perform a lookup operation based on the determined condition of the subject to select the appropriate target compression depth at which future chest compressions are to be administered to the subject 104 for treating the condition of the subject 104. In some examples, the processor(s) may be configured to determine whether or not to provide feedback, and/or what type of feedback to provide, to the rescuer 204 with respect to compression depth by comparing the current compression depth to the target compression depth for treating the condition of the subject 104. That is, the processor(s) may compare the current compression depth to the target compression depth to determine whether the current compression depth is less than, equal to, or greater than the target compression depth, which can be used to determine whether and what type of feedback to provide to the rescuer 204 with respect to compression depth.

In response to determining that the subject 104 has a condition that may benefit from deeper compressions, such as PEA, refractory VF, recurrent VF, or asystole, and in response to determining that the current compression depth (to which the rescuer 204 is manually administering chest compressions) is less than a target compression depth for treating the condition, the processor(s) of the CPR feedback system 202, in some examples, is configured to cause a signal(s) to be output as feedback for the rescuer 204 to administer future chest compressions to the subject 104 at the target compression depth. In the example of FIG. 2, this feedback instructs the rescuer 204 to “compress deeper” (e.g., deeper than the current compression depth).

In some examples, the defibrillator 208 is configured to output a signal(s) as the feedback for the rescuer 204 to increase the compression depth (e.g., by pushing harder and/or longer on the chest of the subject 104 to administer deeper chest compressions). In some examples, the rescuer device 212 is configured to output a signal(s) as the feedback for the rescuer 204 to increase the compression depth. The signal(s) that is output as the feedback for the rescuer 204 may include an audible signal(s), a visual signal(s), and/or a haptic signal(s). FIG. 2 illustrates an example audible signal(s) 220 that may be output by the defibrillator 208 as feedback for the rescuer 204 to increase the compression depth. The audible signal(s) 220 may be output via a speaker(s) of the defibrillator 208. In some examples, the rescuer device 212 is configured to output a similar audible signal(s) 220 via a speaker(s) of the rescuer device 212. In some examples, the audible signal(s) 220 includes synthesized speech that provides verbal feedback (e.g., “compress deeper,” “try pressing harder on the chest,” etc.).

FIG. 2 further illustrates an example visual signal(s) 222 that may be output by the defibrillator 208 as feedback for the rescuer 204 to increase the compression depth. The visual signal(s) 222 may be output via a display(s) of the defibrillator 208, one or more light emitting elements (e.g., a LED(s)) of the defibrillator 208, and/or other output devices of the defibrillator 208. In some examples, the rescuer device 212 is configured to output a similar visual signal(s) 222 via a display(s) of the rescuer device 212. In some examples, the visual signal(s) 222 includes text (e.g., “compress deeper,” “try pressing harder on the chest,” etc.), a graphic, a picture, and/or a video showing correct the target compression depth, an arrow indicating a direction in which to compress deeper (e.g., orthogonal to the chest and towards the chest), and/or other types of visual signals.

FIG. 2 further illustrates an example haptic signal(s) 224 that may be output by the CPR feedback device 206 as feedback for the rescuer 204 to increase the compression depth. The haptic signal(s) 224 may be output via a haptic actuator(s) (e.g., a linear resonant actuator (LRA), an eccentric rotating mass (ERM), a piezoelectric actuator, etc.) of the CPR feedback device 206. In some examples, the defibrillator 208 and/or the rescuer device 212 is configured to cause the haptic signal(s) 224 to be output by the CPR feedback device 206, such as by transmitting an instruction(s) to output the haptic signal(s) 224. In some examples, the CPR feedback device 206 may include output devices (e.g., lights, speakers, etc.) to output the audible signal(s) 220 and/or the visual signal(s) 222 (described above) based on a similar instruction(s) received from the defibrillator 208 and/or the rescuer device 212. In an example, the output device(s) (of the CPR feedback device 206, the rescuer device 212, and/or the defibrillator 208) is an LED configured to emit light of various wavelengths or colors. In this example, to provide a visual feedback signal(s) 222 as feedback to increase the compression depth, the LED may emit red-colored light, which may be a visual signal for the rescuer 204 to increase the compression depth (e.g., to press harder and/or longer on the chest of the subject 104 until the LED emits a green-colored light indicative of correct compression depth. In some examples, the rescuer device 212 is configured to output the haptic signal(s) 224, such as a rescuer device 212 that is worn by the rescuer 204 (e.g., a smart watch with a haptic actuator).

Upon receiving the feedback from the CPR feedback system 202, the rescuer 204 can utilize the feedback to adjust their technique for administering the chest compressions to the subject 104. For example, by observing/hearing/feeling the feedback signal(s) that is being output audibly, visually, and/or haptically by the CPR feedback system 202 of FIG. 2, the rescuer 204 can adjust their technique by, for example, administering chest compressions at a deeper/greater compression depth than before. In other words, the feedback provided to the rescuer 204 may be specifically designed for the rescuer 204 to dynamically adjust how hard they are pressing on the chest of the subject 104 in order to resolve the current issue, which may increase blood flow to help to restore cardiac mechanical function and/or reduce the heart's propensity to be in VF.

FIG. 2 further illustrates a pad 226 that may be positioned underneath the subject 104, the pad including one or more ultra-wide band (UWB) units 228. In some examples, the UWB unit(s) 228 can be used to determine the chest size of the subject 104 (e.g., the height of the chest of the subject 104). For example, the UWB unit(s) 228 is configured to transmit a UWB signal into and/or towards the subject 104, and the UWB signal may be reflected by the CPR feedback device 206 and/or the electrode pads 210 disposed on the chest of the subject 104 so that at least a portion of the reflected UWB signal is received by the UWB unit(s) 228. The received portion of the reflected UWB signal is processed to determine a location of the CPR feedback device 206 and/or the electrode pads 210 and/or a distance of the CPR feedback device 206 and/or the electrode pads 210 relative to the UWB unit(s) 228. In some examples, the processor(s) of the CPR feedback system 202 is configured to determine the time it took for the transmitted UWB signal to travel from the UWB unit(s) 228 to the CPR feedback device 206 and/or the electrode pads 210 and back to the UWB unit(s) 228 to determine the distance based on the rate at which the UWB signal travels. This determined distance can then be used to determine the chest size (e.g., chest height) of the subject 104. U.S. Pat. No. 11,833,106, which is incorporated by reference herein in its entirety, describes UWB units that may be used for determining the chest size (e.g., chest height) of the subject 104.

One reason for determining the chest size of the subject 104 is to mitigate, if not prevent, injury to the subject 104 by the administration of deeper chest compressions. Deeper chest compressions increase the risk of injury to the subject 104 because the compressions are more forceful and deform the chest cavity to a greater extend. Notwithstanding this risk, taking into account the relatively low survival rate of subjects with conditions such as PEA, refractory VF, recurrent VF, and asystole, the advantages of deeper chest compressions to treat subjects with such conditions may outweigh the disadvantage of increasing the risk of injury to the subject. For certain patient populations (e.g., pediatric, teens, small adults, etc.), the risk of injuring the subject may be too high (e.g., almost certain) that it is not advisable to perform deeper chest compressions.

Accordingly, the processor(s) of the CPR feedback system 202 may be configured to receive an indication of a size of a chest of the subject 104. Such an indication may be received from the UWB unit(s) 228, in some examples. In some examples, such an indication may be received from an accelerometer disposed on the chest of the subject 104, such as an accelerometer of the CPR feedback device 206 that is calibrated to indicate height above a fixed reference point (e.g., the ground, the back of the subject 104, etc.). In some examples, the rescuer 204 may observe (e.g., visually) the chest size of the subject 104 and/or measure the chest size with a measuring tool (e.g., a tape measure), and the rescuer 204 can input the chest size using an input device(s) of the defibrillator 208, the rescuer device 212, and/or the CPR feedback device 206, and/or the rescuer 204 may otherwise confirm that the size of the chest of the subject 104 satisfies a threshold size that is reasonably low risk for administering deeper chest compressions. In some examples, an output device(s) of the CPR feedback system 202 (e.g., an output device of the defibrillator 208, the rescuer device 212, and/or the CPR feedback device 206) may prompt the rescuer 204 to confirm that the size of the subject satisfies the threshold size (e.g., by prompting the rescuer 204 to confirm that the subject 104 is an adult), and the rescuer 204 may provide confirmatory user input in response to the prompt if the subject 104 has an above-threshold chest size.

In some examples, the processor(s) of the CPR feedback system 202 receives an indication, or otherwise determines, that the size of the chest of the subject 104 satisfies the threshold size. “Satisfying” a threshold, as used herein, can mean equal to or greater than the threshold, or strictly greater than the threshold. In response to receiving the indication, or otherwise determining, that the size of the chest of the subject 104 satisfies the threshold size, the processor(s) cause a signal(s) to be output as feedback for the rescuer 204 to administer future chest compressions to the subject 104 at a target compression depth for potentially treating the condition (e.g., PEA, refractory VF, recurrent VF, asystole, etc.) of the subject 104, which may be deeper than the current compression depth to which the rescuer 204 is administering chest compressions to the subject 104. This can ensure that the subject 104 is large enough to likely tolerate the deeper chest compressions, thereby avoiding injury to the subject 104.

In some examples, after providing feedback to the rescuer 204 to dynamically increase, the compression depth, the processor(s) of the CPR feedback system 202 is configured to continue monitoring the condition to determine whether the subject 104 no longer has the condition, and, upon making such a determination, the processor(s) of the CPR feedback system 202 may cause an output device to output a signal(s) as feedback for the rescuer 204 to decrease the compression depth (or otherwise revert to a previous compression depth that is shallower than the increased compression depth that was used to treat the condition). In this manner, the CPR feedback system 202 is configured to continuously and dynamically output feedback to adjust the compression depth in either direction (e.g., by increasing the compression depth or by decreasing the compression depth), depending on the current condition of the subject 104 and whether deeper compressions may be beneficial to the outcome of the subject 104.

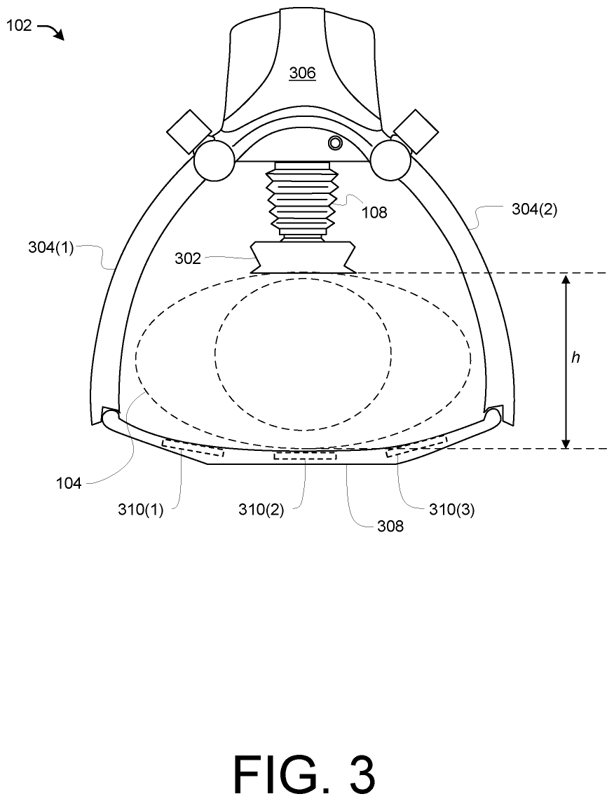

FIG. 3 illustrates the example mechanical chest compression device 102 depicted in FIG. 1, FIG. 3 depicting various example components of the mechanical chest compression device 102 to, among other things, determine a chest size of the subject 104. In the example of FIG. 3, the chest compressing mechanism 108 is in the form of a piston. The distal end of the chest compressing mechanism 108 (e.g., piston) is configured to contact a chest of the subject 104 when the mechanical chest compression device 102 is secured around the subject 104 (e.g., around a thorax thereof). In an example, the distal end of the chest compressing mechanism 108 (e.g., piston) may include a suction cup 302 that is configured to adhere to the chest of the subject 104 in order to actively decompress the chest by pulling upward on the chest.

In the example of FIG. 3, the mechanical chest compression device 102 further includes a pair of legs 304 extending from a main portion 306, each leg 304(1), 304(2) of the pair of legs 304 configured to connect to a respective side of a backplate 308. The backplate 308 is configured to be disposed under the back of the subject 104 and in contact with the back of the subject 104. In some examples, a chest size of the subject 104 is determined based on a position of the chest compressing mechanism 108 (e.g., piston) at a time at which the mechanical chest compression device 102 is activated with the chest compressing mechanism 108 (e.g., piston) disposed on the chest of the subject 104. For example, when the mechanical chest compression device 102 is secured around the subject 104 (e.g., around a thorax thereof), a rescuer may activate the mechanical chest compression device 102 (e.g., by pressing a power button, switching a power switch, etc.), and at this time, the processor(s) 106 of the mechanical chest compression device 102, with knowledge of the current position of the chest compressing mechanism 108 (e.g., piston) and the distance from the distal end of the chest compressing mechanism 108 (e.g., piston) at the current position to the backplate 308 (e.g., the center of the backplate 308), the processor(s) 106 may determine the chest size of the subject 104 based on the distance from the distal end of the chest compressing mechanism 108 (e.g., piston) to the backplate 308. As shown in FIG. 3, the chest size can be determined as a height, h, of the chest of the subject 104. Accordingly, the processor(s) 106 of the mechanical chest compression device 102 may be configured to receive an indication of the size of the chest of the subject 104 (e.g., chest height, h) and/or an indication that the chest size of the subject 104 satisfies a threshold size (e.g., a threshold chest height) based at least in part on the position of the chest compressing mechanism 108 (e.g., piston) when the mechanical chest compression device 102 is activated. It is to be appreciated, however, that other chest size measurements can be used as a proxy for the height, h, of the chest, such as a width of the chest, a length of the chest, a circumference of the thorax, and/or the like.

In some examples, one or more UWB units 310 may be integrated in, or disposed on, the backplate 308, the UWB unit(s) 310 being usable to determine the chest size of the subject 104 (e.g., the height, h, of the chest of the subject 104). Similar to the above description of the UWB unit(s) 228 with reference to the CPR feedback system 202 of FIG. 2, the UWB unit(s) 310 of the mechanical chest compression device 102 may be configured to transmit a UWB signal into and/or towards the subject 104, and the UWB signal may be reflected by the chest compressing mechanism 108 (e.g., piston) and/or the suction cup 302 thereof, which is disposed on the chest of the subject 104. In this manner, at least a portion of the reflected UWB signal is received by the UWB unit(s) 310, and the received portion of the reflected UWB signal is processed to determine a location of the chest compressing mechanism 108 (e.g., piston) and/or the suction cup 302 thereof and/or a distance of the chest compressing mechanism 108 (e.g., piston) and/or the suction cup 302 thereof relative to the UWB unit(s) 310. In some examples, the processor(s) 106 of the mechanical chest compression device 102 is configured to determine the time it took for the transmitted UWB signal to travel from the UWB unit(s) 310 to the chest compressing mechanism 108 (e.g., piston) and/or the suction cup 302 thereof and back to the UWB unit(s) 310 to determine the distance based on the rate at which the UWB signal travels. This determined distance can them be used to determine the chest size (e.g., chest height, h) of the subject 104.

FIG. 3 shows that a second UWB unit 310(2) is positioned substantially in the center of the backplate 308, and that a first UWB unit 310(1) and a third UWB unit 310(3) are positioned away from the center and closer to the sides of the backplate 308. A single UWB unit 310(2) positioned substantially in the center of the backplate where it will contact the back of the subject 104 may be sufficient for chest size determination, although the additional UWB units 310(1) and/or 310(3) may be used for redundancy and/or a more robust and accurate determination of chest size. Additionally, or alternatively, the UWB unit(s) 310 may be used in addition to, or in lieu of, the position of the chest compressing mechanism 108 (e.g., piston) to determine the chest size of the subject 104. In examples where both approaches are utilized, the UWB unit(s) 310 may be used as a corroborating signal to corroborate a chest size determined based on the position of the chest compressing mechanism 108, or vice versa.

Accordingly, the processor(s) 106 of the mechanical chest compression device 102 may be configured to receive an indication of a size of a chest of the subject 104 (e.g., chest height, h). Such an indication may be received based on the position of the chest compressing mechanism 108 (e.g., piston), and/or from the UWB unit(s) 310, in some examples. In some examples, a rescuer may observe (e.g., visually) the chest size of the subject 104 and/or measure the chest size with a measuring tool (e.g., a tape measure), and the rescuer can input the chest size using an input device(s) 110 of the mechanical chest compression device 102, and/or the rescuer may otherwise confirm that the size of the chest of the subject 104 satisfies a threshold size that is reasonably low risk for administering deeper chest compressions. In some examples, an output device(s) 112 of the mechanical chest compression device 102 may prompt the rescuer to confirm that the size of the subject satisfies the threshold size (e.g., by prompting the rescuer to confirm that the subject 104 is an adult), and the rescuer may provide confirmatory user input in response to the prompt if the subject 104 has an above-threshold chest size.

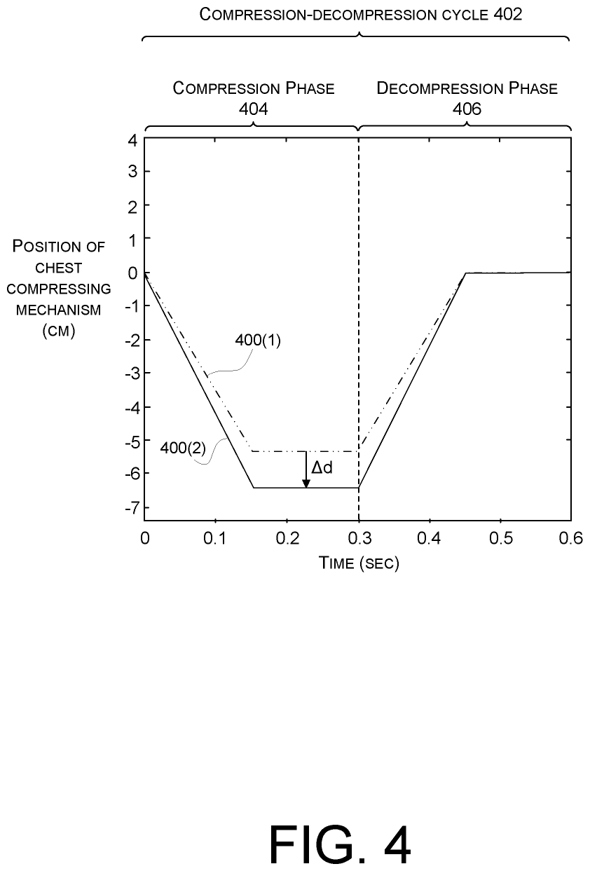

FIG. 4 illustrates two compression and decompression profiles (or, “waveforms” 400), one waveform 400(1) exhibiting a shallower compression depth, and the other waveform 400(2) exhibiting a deeper compression depth. As shown in FIG. 4, a compression-decompression cycle 402 includes a compression phase 404 followed by a decompression phase 406. Although a 50:50 duty cycle is shown in FIG. 4 with the compression phase 404 and the decompression phase 406 being equal in duration, it is to be appreciated that other duty cycles can be implemented with the techniques, devices, and systems described herein, such as a duty cycle where the compression phase 404 is shorter than the decompression phase 406 (e.g., a 40:60 duty cycle). With the 50:50 duty cycle, and with a compression rate of 100 compressions per minute, depicted in FIG. 4, the first 0.3 seconds of the compression-decompression cycle 402 represents the compression phase 404 and the last 0.3 seconds of the compression-decompression cycle 402 represents the decompression phase 406.

In some examples, the first waveform 400(1) corresponds to a first operating mode (e.g., a normal compression mode) of the mechanical chest compression device 102. In this first mode, the first waveform 400(1) indicates that the chest compressing mechanism 108 of the mechanical chest compression device 102 starts at a first position of 0 centimeters (cm), and begins moving (e.g., downward, towards the subject 104) at a constant velocity until the chest compressing mechanism 108 arrives at a second position of about negative 5.3 cm. This second position (negative 5.3 cm) of the chest compressing mechanism 108 may represent a first target compression depth, and the chest compressing mechanism 108 arrives at the first target compression depth at about 0.15 seconds into the compression-decompression cycle 402. After arriving at the second position (negative 5.3 cm), the chest compressing mechanism 108 refrains from moving during a first hold period that spans from about 0.15 seconds to 0.3 seconds into the compression-decompression cycle 402. For different duty cycles and/or compression rates, this first hold period can be shorter. In the example of FIG. 4, at 0.3 seconds into the compression-decompression cycle 402, the chest compressing mechanism 108, which is at the second position (negative 5.3 cm), begins moving (e.g., upward, away from the subject 104) at a constant velocity until the chest compressing mechanism 108 returns to the first position of 0 cm at about 0.45 seconds into the compression-decompression cycle 402. After returning to the first position (0 cm), the chest compressing mechanism 108 refrains from moving during a second hold period that spans from about 0.45 seconds to 0.6 seconds, which marks the end of the compression-decompression cycle 402. Again, for different duty cycles and/or compression rates, this second hold period can be longer or shorter. Additionally, or alternatively, the mechanical chest compression device 102 may be configured to implement active decompression during the decompression phase 406, whereby the chest compressing mechanism 108 continues moving past the first position (0 cm) at 0.45 seconds into the compression-decompression cycle 1002 and stops moving at a third position greater than 0 cm to initiate the second hold period at a position where the chest is being held in a decompressed state by actively applying an upward force to the chest (e.g., by pulling on the chest using the suction cup 302 of the mechanical chest compression device 102). Although the first waveform 400(1) depicted in FIG. 4 is trapezoidal in shape, this is non-limiting, as the first waveform 400(1) can be of any suitable shape, such as a sinusoidal waveform, a triangular-shaped (e.g., sawtooth) waveform, a rectangular-shaped waveform, a square-shaped waveform, or a waveform having any suitable polygonal shape.

As described herein, the processor(s) 106 of the mechanical chest compression device 102 is configured to receive an indication 114 that the subject 104 has a condition that may benefit from deeper chest compressions (e.g., PEA, refractory VF, recurrent VF, asystole, etc.), and in response to receiving the indication 114 that the subject 104 has the condition (e.g., PEA, refractory VF, recurrent VF, asystole, etc.), the processor(s) 106 is configured to cause (e.g., by providing the instruction(s) 116) the chest compressing mechanism 108 to increase a current target compression depth to an increased target compression depth at which future chest compressions are to be administered to the subject 104. In some examples, this involves the processor(s) 106 causing the mechanical chest compression device 102 to switch to operating in a second mode (e.g., an enhanced compression mode).

In some examples, the second waveform 400(2) corresponds to the second operating mode (e.g., the enhanced compression mode) of the mechanical chest compression device 102. In this second mode, the second waveform 400(2) indicates that the chest compressing mechanism 108 of the mechanical chest compression device 102 starts at a first position of 0 cm, and begins moving (e.g., downward, towards the subject 104) at a constant velocity until the chest compressing mechanism 108 arrives at a second position of about negative 6.5 cm. This second position (negative 6.5 cm) of the chest compressing mechanism 108 may represent a second target compression depth, which may be a suitable compression depth for treating a condition such as PEA, refractory VF, recurrent VF, or asystole. In the second waveform 400(2), the chest compressing mechanism 108 arrives at the second target compression depth at about 0.15 seconds into the compression-decompression cycle 402, which means that the chest compressing mechanism 108 moves faster during this portion of the compression phase 404 in the second operating mode, as compared to the speed at which the chest compressing mechanism 108 moves during this portion of the compression phase 404 in the first operating mode. After arriving at the second position (negative 6.5 cm), the chest compressing mechanism 108 refrains from moving during a first hold period that spans from about 0.15 seconds to 0.3 seconds into the compression-decompression cycle 402. Again, for different duty cycles and/or compression rates, this first hold period can be shorter. In the example of FIG. 4, at 0.3 seconds into the compression-decompression cycle 402, the chest compressing mechanism 108, which is at the second position (negative 6.5 cm), begins moving (e.g., upward, away from the subject 104) at a constant velocity until the chest compressing mechanism 108 returns to the first position of 0 cm at about 0.45 seconds into the compression-decompression cycle 402, which means that the chest compressing mechanism 108 moves faster during this portion of the decompression phase 406 in the second operating mode, as compared to the speed at which the chest compressing mechanism 108 moves during this portion of the decompression phase 406 in the first operating mode. After returning to the first position (0 cm), the chest compressing mechanism 108 refrains from moving during a second hold period that spans from about 0.45 seconds to 0.6 seconds, which marks the end of the compression-decompression cycle 402. Again, for different duty cycles and/or compression rates, this second hold period can be longer or shorter. Additionally, or alternatively, the mechanical chest compression device 102 may be configured to implement active decompression during the decompression phase 406, as described above. Accordingly, FIG. 4 illustrates a change in the target compression depth (e.g., Δd) when the mechanical chest compression device 102 is switched from the first operating mode (e.g., the normal compression mode) to the second operating mode (e.g., the enhanced compression mode), which may occur automatically, semi-automatically, or in response to user input received via the input device(s) 110 to change the operating mode.

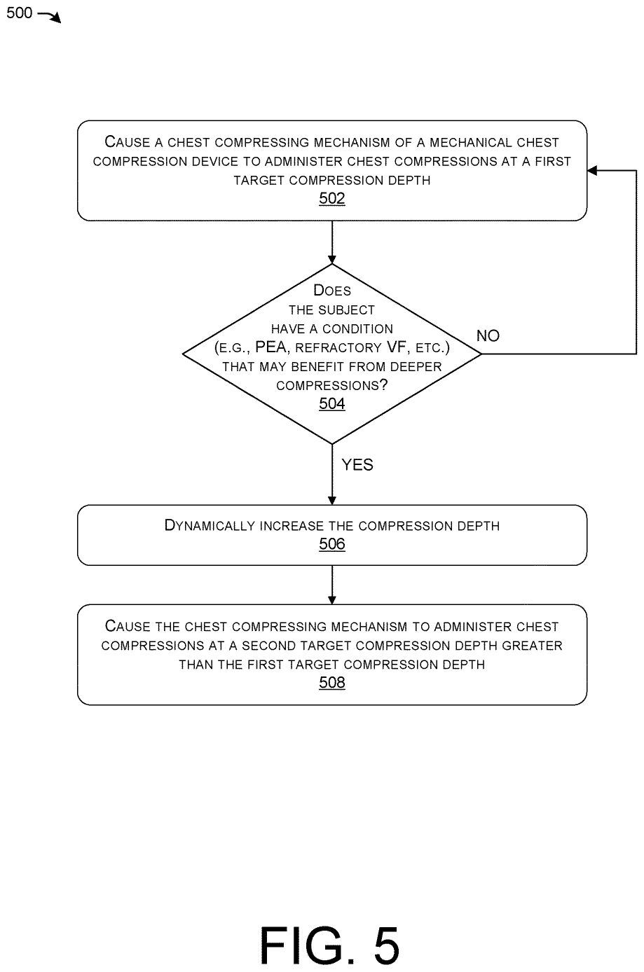

FIGS. 5, 6, and 7 illustrate processes and/or techniques performed by one or more systems, devices, or entities described herein. For example, the processes/techniques illustrated in FIGS. 5, 6, and 7 may be implemented by a CPR system and/or device, whether the device is a standalone device or part of a CPR system, and/or by at least one processor configured to execute instructions. The processes described herein represent sequences of operations that can be implemented in hardware, software, or a combination thereof. In the context of software, the blocks represent computer-executable instructions stored on one or more computer-readable storage media that, when executed by a processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes. In some examples, an operation(s) of the process may be omitted entirely. Moreover, the processes described herein can be combined in whole or in part with each other or with other processes.

FIG. 5 illustrates an example process 500 dynamically increasing a compression depth of automated chest compressions administered by a mechanical chest compression device in response to a determination that the subject has a condition that may benefit from deeper compressions, such as PEA, refractory VF, recurrent VF, or asystole. The process 500 is performed by an entity including, for example, one or more devices of a CPR system, such as the mechanical chest compression device 102 of FIG. 1, the mechanical chest compression device 900 of FIG. 9, a processor(s) of any of the aforementioned devices and/or a processor(s) of any other device(s) that is part of a CPR system.

At 502, the entity causes movement of a chest compressing mechanism 108 of a mechanical chest compression device 102 to administer chest compressions to a subject 104 at a first target compression depth. In some examples, the chest compressing mechanism 108 administers the chest compressions to the subject 104 at 502 by repeatedly applying a force to the chest of the subject 104 (e.g., the piston extending and applying a downward force to the chest of the subject 104) and releasing the force in between successive applications of the force (e.g., the piston retracting away from the chest of the subject 104 in between successive extensions where downward force is applied to the chest of the subject 104). This movement of the chest compressing mechanism 108 may continue at 502 over a series of compression-decompression cycles for administering chest compressions to the subject 104 at the first target compression depth. However, the type of movement of the chest compressing mechanism 108 may depend on the type of mechanical chest compression device that is utilized for administering CPR treatment to the subject 104. For example, a piston-based mechanical chest compression device 102, as shown in FIG. 1, includes a chest compressing mechanism 108 in the form of a piston, and the piston is configured to be placed on the chest of the subject 104 and to repeatedly extend and/or move downward, toward the subject 104, to apply a downward force to the chest for administering chest compressions to the subject 104 and to release the applied force by retracting and/or moving upward, away from the subject 104, in between successive applications of the downward force. As another example, a vest-based mechanical chest compression device includes a chest compressing mechanism in the form of a load-distributing band, and the load-distributing band is configured to be placed on the chest of the subject 104 and to repeatedly apply a distributed (squeezing) force that is directed inward towards the chest for administering chest compressions to the subject 104 and to release the applied force in between successive applications of the force. In some examples, the entity, at 502, causes the mechanical chest compression device 102 to operate in a first mode (e.g., a normal compression mode) where the chest compressing mechanism 108 administers the chest compressions at the first target compression depth. In other words, the mechanical chest compression device 102 may be configured to operate in one of multiple different modes, and to switch between modes automatically, semi-automatically, or in response to user input received via the input device(s) 110 to change the operating mode, as described herein. The first mode of operation may be a default mode of operation, or a mode selected by an operator (e.g., a rescuer).

At 504, the entity determines whether the subject 104 has a condition that may benefit from deeper compressions. This determination may be based at least in part on whether the entity received an indication 114 or not, as described above. If the entity has not received such an indication, the process 500 follows the NO route from block 504 back to block 502 where the entity continues to cause movement of the chest compressing mechanism 108 to administer chest compressions to the subject 104 at the first target compression depth. That is, by following the NO route from block 504, the entity refrains from changing the target compression depth. If, on the other hand, the entity receives an indication 114 that the subject 104 has the condition (e.g., PEA, refractory VF, recurrent VF, asystole, etc.), the process 500 follows the YES route from block 504 to block 506. In some examples, such an indication 114 may be received from a monitor-defibrillator communicatively coupled with the mechanical chest compression device 102. For example, the monitor-defibrillator may be connected to sensors and/or equipped with electrode pads and a detection circuit configured to detect various physiological conditions, such as PEA, refractory VF, recurrent VF, asystole, low blood pressure, low blood flow, etc., and, if such a condition is detected and is known to potentially benefit from deeper compressions, the monitor-defibrillator may send the indication 114 to the mechanical chest compression device 102. In some examples, the indication 114 is received in response to receiving user input via an input device(s) 110 of the mechanical chest compression device 102 to change the operating mode to a second mode (e.g., an enhanced compression mode). In some examples, the indication 114 is received in response to receiving user input via the input device(s) 110 of the mechanical chest compression device 102 confirming that the subject 104 has the condition that may benefit from deeper compressions, such as PEA, refractory VF, recurrent VF, or asystole. In some examples, the entity may cause an output device(s) 112 of the mechanical chest compression device 102 to output a prompt to a rescuer to confirm that the subject 104 has the condition (e.g., PEA, refractory VF, recurrent VF, asystole, etc.), and the indication 114 is received based on user input responding to the prompt (e.g., confirmatory user input received via the input device(s) 110). In some examples, determining that the subject 104 has the condition (e.g., PEA, refractory VF, recurrent VF, asystole, etc.) at 504 includes determining an amount of time that the subject 104 has had the condition, and the process 500 follows the YES route from block 504 to block 506 if the amount of time satisfies a threshold amount of time. In this example, the amount of time that the subject 104 has had the condition can be measured as a number of seconds, a number of minutes, a number of compression-decompression cycles, and/or the like. To illustrate an example where the amount of time is measured as a number of compression-decompression cycles, the process 500 may follow the YES route from block 504 to block 506 if it is determined, at 504, that the subject 104 has had the condition for one compression-decompression cycle, two compression-decompression cycles, three compression-decompression cycles, or any other threshold number of compression-decompression cycles. For example, a subject 104 with PEA may receive chest compressions at a standard compression depth for three compression-decompression cycles, and if the subject 104 still has PEA after the third compression-decompression cycle, the process 500 may follow the YES route from block 504 to block 506. This approach of waiting to increase the compression depth instead of immediately increasing the compression depth upon determining that the subject 104 has the condition may be a cautious approach that utilizes deeper compressions if compressions administered at a standard compression depth are not helping the subject 104 recover from their present condition.

At 506, in response to receiving the indication 114, or otherwise determining, at 504, that the subject 104 has the condition that may benefit from deeper compressions (e.g., upon determining, at 504, that the subject 104 has had the condition for an amount of time that satisfies a threshold amount of time), the entity dynamically increases the compression depth. For example, the entity causes the chest compressing mechanism 108 to increase a current/first target compression depth to an increased/second target compression depth at which future chest compressions are to be administered to the subject 104. This may involve changing a compression depth parameter of a software program that is being executed to operate the mechanical chest compression device 102, and specifically a software program that controls the movement of the chest compressing mechanism 108. In some examples, the entity provides an instruction(s) 116 at 506 that causes the compression depth to increase by a predefined amount (e.g., by instructing the chest compressing mechanism 108 to administer future chest compressions at a compression depth that is 0.5 cm deeper than the current target compression depth). In some examples, the increased/second target compression depth is greater than 6 cm. In examples where the mechanical chest compression device 102 is operable in multiple different modes, the respective operating modes may correspond to respective compression depths that are different, and the entity may select the increased/second target compression depth that corresponds to the operating mode to which the mechanical chest compression device 102 is being switched. In some examples, a plurality of target compression depths are defined for treating a plurality of conditions that may benefit from deeper chest compressions, and the entity selects, at 506, the increased/target compression depth for treating the determined condition. For example, if the subject 104 has PEA, the entity may select, at 506, a second target compression depth for treating PEA. Alternatively, if the subject 104 has refractory VF, the entity may select, at 506, a second target compression depth for treating refractory VF.

At 508, the entity causes movement of the chest compressing mechanism 108 to administer chest compressions to a subject 104 at the increased/second target compression depth. For example, a piston-based mechanical chest compression device 102, as shown in FIG. 1, may start administering chest compressions by repeatedly moving downward, toward the subject 104 to a greater extent so that deeper compressions are administered at 508, as compared to the compressions administered at 502. In some examples, the entity, at 508, causes the mechanical chest compression device 102 to switch to operating in a second mode where the chest compressing mechanism administers the chest compressions at a second target compression depth greater than the first target compression depth. In some examples, this switching of operating modes may occur automatically in response to the determination at 504 that the subject has the condition that may benefit from deeper compressions. In some examples, the mode switching may occur semi-automatically (e.g., by the entity detecting the condition and prompting the rescuer to confirm that the subject 104 has the condition before switching to the second mode).

As mentioned above, the condition of the subject 104 may continue to be monitored to determine whether to decrease the compression depth (or otherwise revert to a previous, shallower compression depth) if, say, the condition subsides and/or is resolved by the deeper chest compressions administered at 508. Accordingly, the process 500 may iterate by decreasing the compression depth in between successive iterations of the process 500, where the decrease in the compression depth may occur based on a determination that the subject 104 no longer has the condition (e.g., PEA, refractory VF, recurrent VF, asystole, etc.).

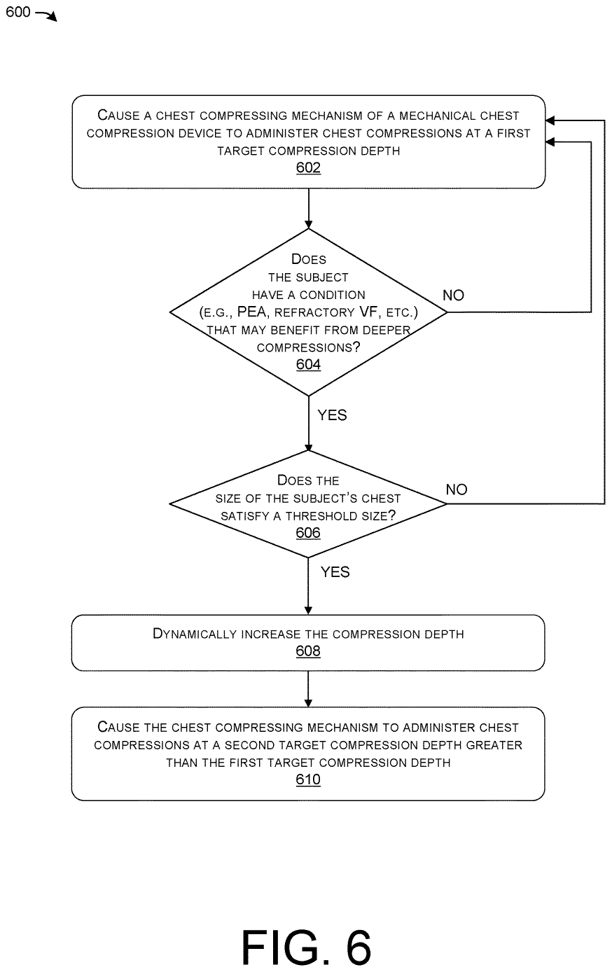

FIG. 6 illustrates an example process 600 for dynamically increasing a compression depth of automated chest compressions administered by a mechanical chest compression device in response to a determination that the subject has a condition that may benefit from deeper compressions, such as PEA, refractory VF, recurrent VF, or asystole, and in response to a determination that the chest size of the subject satisfies a threshold size. The process 600 is performed by an entity including, for example, one or more devices of a CPR system, such as the mechanical chest compression device 102 of FIG. 1, the mechanical chest compression device 900 of FIG. 9, a processor(s) of any of the aforementioned devices and/or a processor(s) of any other device(s) that is part of a CPR system.

At 602, the entity causes movement of a chest compressing mechanism 108 of a mechanical chest compression device 102 to administer chest compressions to a subject 104 at a first target compression depth. The operations performed at 602 may be similar to the operations performed at 502 of the process 500, as described above. For the sake of brevity, those operations will not be repeated here.

At 604, the entity determines whether the subject 104 has a condition that may benefit from deeper compressions. The operations performed at 604 may be similar to the operations performed at 504 of the process 500, as described above. For the sake of brevity, those operations will not be repeated here. If, at 604, the entity receives an indication 114 that the subject 104 has the condition (e.g., PEA, refractory VF, recurrent VF, asystole, etc.), the process 600 follows the YES route from block 604 to block 606.

At 606, the entity determines whether a size of the chest of the subject 104 satisfies a threshold size. This determination may be based at least in part on whether the entity received an indication that the chest size of the subject satisfies a threshold size or not. In some examples, such an indication is received from a UWB unit(s) 310, as described above. In examples where the chest compressing mechanism 108 is a piston of a piston-based mechanical chest compression device 102, such an indication may be received based on a position of the piston at a time at which the mechanical chest compression device 102 is activated with the piston disposed on the chest of the subject 104, as described above. In some examples, such an indication is received in response to receiving user input via the input device(s) 110 of the mechanical chest compression device 102, the user input confirming that the size of the chest of the subject 104 satisfies the threshold size. In some examples, the entity causes an output device(s) 112 of the mechanical chest compression device 102 to output a prompt for a rescuer to confirm that the size of the chest of the subject 104 satisfies the threshold size, and the indication is received in response to user input received in response to outputting the prompt. If the chest size of the subject 104 does not satisfy the threshold size, the process 600 follows the NO route from block 606 back to block 602 where the entity continues to cause movement of the chest compressing mechanism 108 to administer chest compressions to the subject 104 at the first target compression depth. That is, by following the NO route from block 604, the entity refrains from changing the target compression depth. This may help to mitigate injury of subjects with smaller chest sizes (e.g., pediatric subjects). If, on the other hand, the chest size of the subject 104 satisfies the threshold size, the process 600 follows the YES route from block 606 to block 608.

At 608, in response to receiving a first indication, or otherwise determining, at 604, that the subject 104 has the condition that may benefit from deeper compressions, and in response to receiving a second indication, or otherwise determining, at 606, that the chest size of the subject 104 satisfies the threshold size, the entity dynamically increases the compression depth. The operations performed at 608 may be similar to the operations performed at 506 of the process 500, as described above. For the sake of brevity, those operations will not be repeated here. Additionally, or alternatively, in some examples, the increased/second target compression depth is selected at 608 based at least in part on the chest size of the subject 104. For example, the entity may, at 608, select a second target compression depth from a plurality of target compression depths that are respectively associated with a plurality of chest sizes and/or patient types. For example, a smaller chest size may be associated with a relatively shallower target compression depth, and a larger chest size may be associated with a relatively deeper target compression depth such that the processor(s) 106 may select the appropriate target compression depth that is customized to the subject 104. In examples where the chest size of the subject 104 is, or includes, a height, h, of the chest of the subject 104, the entity may increase the compression depth at 608 to an increased/second compression depth that is less than a threshold percentage of the height, h, of the chest of the subject 104, such as less than 45% of the height, h, less than 40% of the height, h, less than 30% of the height, h, and/or the like. This type of customization to the subject 104 may allow for increasing the compression depth while mitigating injury by compressing “deeper,” but not “too deep” for the given subject 104. In some examples, the entity may be configured to increase the compression depth up to a safety limit without exceeding the safety limit. In some examples, there is an absolute safety limit for all subjects, regardless of the chest size (e.g., chest height) of the subject, and the compression depth may not ever exceed the absolute safety limit to mitigate injury. In some examples, a customized safety limit is determined for an individual subject 104 based at least in part on the chest size (e.g., chest height, h) of the subject 104. For example, the safety limit may be determined for the subject 104 as a safety limit of no greater than 45% of the height, h, of the chest of the subject 104, no greater than 40% of the height, h, of the chest of the subject 104, no greater than 30% of the height, h, of the chest of the subject 104, and/or the like. In this example, the entity may be configured to increase the compression depth up to the customized safety limit without exceeding the customized safety limit. In some examples, the entity is configured to monitor compression force, and if the compression force satisfies a threshold compression force, this may be indicative of a compression depth that is too deep (e.g., the sternum may be hitting the spine). In this scenario where compression force satisfies a threshold compression force, the entity may cause output of an alert (or an alarm) for the rescuer, and/or the entity may dynamically decrease the compression depth to mitigate injury.

At 610, the entity causes movement of the chest compressing mechanism 108 to administer chest compressions to a subject 104 at the increased/second target compression depth. The operations performed at 610 may be similar to the operations performed at 508 of the process 500, as described above. For the sake of brevity, those operations will not be repeated here.

As mentioned above, the condition of the subject 104 may continue to be monitored to determine whether to decrease the compression depth (or otherwise revert to a previous, shallower compression depth) if, say, the condition subsides and/or is resolved by the deeper chest compressions administered at 610. Accordingly, the process 600 may iterate by decreasing the compression depth in between successive iterations of the process 600, where the decrease in the compression depth may occur based on a determination that the subject 104 no longer has the condition (e.g., PEA, refractory VF, recurrent VF, asystole, etc.).

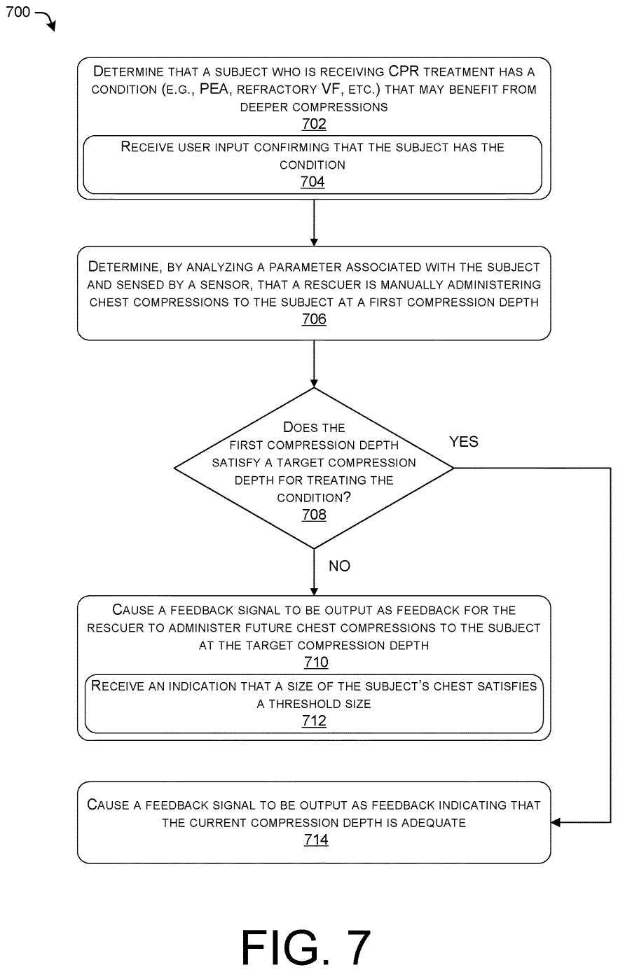

FIG. 7 illustrates an example process 700 for evaluating, in response to a determination that the subject has a condition that may benefit from deeper compressions, such as PEA, refractory VF, recurrent VF, or asystole, a compression depth of chest compressions that are being manually administered to a subject to determine whether to output feedback for the rescuer to increase the compression depth. The process 700 is performed by an entity including, for example, one or more devices of a CPR system, such as one or more devices of the CPR feedback system 202 of FIG. 2, such as the defibrillator 208 of FIG. 2, the defibrillator 800 of FIG. 8, the rescuer device 212 of FIG. 2, the CPR feedback device 206 of FIG. 2, a processor(s) of any of the aforementioned devices and/or a processor(s) of any other device(s) that is part of a CPR system.

At 702, the entity determines that a subject 104 who is receiving a CPR treatment has a condition that may benefit from deeper chest compression, such as PEA, refractory VF, recurrent VF, or asystole. “Deeper,” in this example, can mean deeper than a recommended compression depth of CPR guidelines. Accordingly, if a rescuer 204 is manually administering chest compressions to the subject 104 at a compression depth in accordance with CPR guidelines, the condition of the subject 104 may not be resolved with the chest compressions administered at that compression depth. In some examples, the entity is a component of a monitor-defibrillator (e.g., the defibrillator 208) of a CPR feedback system 202, and the entity determines, at 702, that the subject 104 has the condition (e.g., PEA, refractory VF, recurrent VF, asystole, etc.) by analyzing a physiological parameter of the subject 104. For example, as described above, various sensors may be applied to the subject 104 and connected to the defibrillator 208 and/or the defibrillator 208 may use electrode pads 210 to generate an ECG associated with the subject 104. In these examples, the defibrillator 208 may determine that the subject 104 has the condition (e.g., PEA, refractory VF, recurrent VF, asystole, etc.) based on such physiological parameters.

In some examples, at 704, the entity receives (e.g., via an input device(s) of the defibrillator 208, an input device(s) of the rescuer device 212, an input device(s) of the CPR feedback device 206, etc.) user input confirming that the subject 104 has the condition (e.g., PEA, refractory VF, recurrent VF, asystole, etc.), and the entity determines, at 702, that the subject 104 has the condition (e.g., PEA, refractory VF, recurrent VF, asystole, etc.) in response to receiving the user input via the input device(s) confirming that the subject 104 has the condition. For example, the rescuer 204 may, from observing the subject 104 and/or from observing output of the defibrillator 208, determine that the subject 104 likely has the condition that may benefit from deeper compressions, and may provide user input confirming the same. In some examples, determining that the subject 104 has the condition (e.g., PEA, refractory VF, recurrent VF, asystole, etc.) at 702 includes determining that the subject 104 has had the condition for an amount of time that satisfies a threshold amount of time. In this example, the amount of time that the subject 104 has had the condition can be measured as a number of seconds, a number of minutes, a number of compression-decompression cycles, and/or the like. To illustrate an example where the amount of time is measured as a number of compression-decompression cycles, the determination, at 702, may be a determination that the subject 104 has had the condition for one compression-decompression cycle, two compression-decompression cycles, three compression-decompression cycles, or any other threshold number of compression-decompression cycles. For example, the rescuer 204 may administer chest compressions to a subject 104 with PEA for three compression-decompression cycles, and if the subject 104 still has PEA after the third compression-decompression cycle, the entity may determine, at 702, that the subject 104 has the condition (e.g., because the subject 104 has had the condition for an amount of time that satisfies a threshold amount of time).

At 706, the entity determines, by analyzing a parameter(s) associated with the subject 104 and sensed by a sensor(s), that the rescuer 204 is manually administering the chest compressions to the subject 104 at a first compression depth. In some examples, the sensor(s) is configured to sense a chest compression depth parameter associated with the subject 104 as the rescuer 204 is manually administering chest compressions to the subject 104. For example, the sensor(s) may include an accelerometer that is configured to generate data or electrical signals that are processed to determine how far the accelerometer moved during a compression phase of a compression-decompression cycle. In some examples, the sensor(s) is a sensor(s) 214 of the CPR feedback device 206 depicted in FIG. 2.

At 708, the entity determines whether the first compression depth satisfies a target compression depth for treating the condition of the subject 104. In some examples, the determination at 708 is a determination as to whether the first compression depth is sufficient (or insufficient) to treat the condition of the subject 104. This may involve comparing the first compression depth to the target compression depth to determine whether the first compression depth is less than, equal to, or greater than the target compression depth. Consider an example where the target compression depth is greater than 6 cm (e.g., 6.5 cm) and the first compression depth is 5 cm. In this example, the entity determines, at 708, that the first compression depth fails to satisfy the target compression depth, and the process 700 follows the NO route from block 708 to block 710.

At 710, in response to determining, at 702, that the subject 104 has the condition (e.g., PEA, refractory VF, recurrent VF, asystole, etc.) that may benefit from deeper compressions, and in response to determining, at 708, that the first compression depth fails to satisfy (e.g., is less than) the target compression depth for treating the condition, the entity causes a signal(s) to be output as feedback for the rescuer 204 to administer future chest compressions to the subject 104 at the target compression depth. The signal(s) output at 710 can be an audible signal 220, a visual signal 222, and/or a haptic signal 224. In some examples, the entity is a component of a monitor-defibrillator (e.g., the defibrillator 208) of a CPR feedback system 202, and an audible or a visual signal is output at 710 via an output device (e.g., a display(s) and/or a speaker(s)) of the monitor-defibrillator.

In some examples, at 712, the entity receives an indication that a size of a chest of the subject 104 satisfies a threshold size. In this example, the signal(s) may be output, at 710, in response to receiving the indication, at 712, that the size of the chest of the subject 104 satisfies the threshold size. In other words, if the chest size of the subject 104 does not satisfy the threshold size, the entity may refrain from outputting the signal(s), in some examples, so as to prevent injury to the relatively small-sized subject 104. In some examples, this chest size indication can be received at 712 from a UWB unit(s) 228, as described above. In some examples, this chest size indication can be received at 712 from an accelerometer disposed on the chest of the subject 104 (e.g., an accelerometer of the CPR feedback device 206), as described above. In some examples, this chest size indication can be received at 712 in response to receiving user input via an input device(s) (e.g., an input device(s) of the defibrillator 208, an input device(s) of the rescuer device 212, an input device(s) of the CPR feedback device 206, etc.) confirming that the size of the chest of the subject 104 satisfies the threshold size. For example, the rescuer 204 may observe and/or measure the chest size of the subject 104 and provide confirmatory user input. In some examples, this confirmatory user input is received in response to outputting a prompt via an output device(s) (e.g., an output device(s) of the defibrillator 208, and output device(s) of the rescuer device 212, an output device(s) of the CPR feedback device 206, etc.). For example, the rescuer 204 may be prompted to confirm that the subject 104 is an adult before the entity causes the signal(s) to be output at 710 as feedback for the rescuer 204 to administer future chest compressions to the subject 104 at the target compression depth.

If the entity determines, at 708, that the first compression depth satisfies the target compression depth, the process 700 follows the YES route from block 708 to block 714. At 714, in response to determining that the rescuer 204 is manually administering the chest compressions to the subject 104 at or deeper than the target compression depth, the entity causes a signal(s) to be output as feedback for the rescuer 204 indicating that the current compression depth is adequate (e.g., that the rescuer 204 is administering CPR correctly).

In some examples, after causing the feedback signal(s) to be output at 710 or at 714, the entity may continue evaluating the compression depth of the manual chest compressions based on the chest size of the subject 104 to determine if the rescuer 204 is administering compressions that are too deep for the chest size of the subject 104. That is, for smaller subjects 104 the feedback at 710 may be to administer deeper chest compressions, but not as deep as those that would be recommended for larger subjects 104. In examples where the chest size is a height, h, of the chest of the subject 104, the entity may cause another signal(s) to be output as feedback for the rescuer 204 indicating that the rescuer 204 is compressing too deep if, say, the entity determines that the rescuer 204 is compressing to a compression depth that is greater than a threshold percentage of the height, h, of the chest of the subject 104. As described above, this threshold percentage may be 45%, 40%, 30%, or a similar threshold that is a fraction of the chest height, h, to mitigate injury to the subject 104. In some examples, the entity may be configured cause output of an alert (or an alarm) for the rescuer 204 if the rescuer 204 administers chest compressions to a compression depth that exceeds a safety limit. In some examples, there is an absolute safety limit for all subjects, regardless of the chest size (e.g., chest height) of the subject, and the alert (or alarm) may be output if manually administered chest compressions ever exceed the absolute safety limit to mitigate injury. In some examples, a customized safety limit is determined for an individual subject 104 based at least in part on the chest size (e.g., chest height, h) of the subject 104. For example, the safety limit may be determined for the subject 104 as a safety limit of no greater than 45% of the height, h, of the chest of the subject 104, no greater than 40% of the height, h, of the chest of the subject 104, no greater than 30% of the height, h, of the chest of the subject 104, and/or the like. In this example, the alert (or alarm) may be output if manually administered chest compressions ever exceed the customized safety limit for the particular subject 104. In some examples, the entity is configured to monitor compression force, and if the compression force satisfies a threshold compression force, this may be indicative of a compression depth that is too deep (e.g., the sternum may be hitting the spine). In this scenario where compression force satisfies a threshold compression force, the entity may cause output of an alert (or an alarm) for the rescuer 204, and/or the entity may cause a signal to be output as feedback for the rescuer 204 to decrease the compression depth to mitigate injury.

As mentioned above, the condition of the subject 104 may continue to be monitored to determine whether to output feedback to the rescuer 204 to decrease the compression depth (or otherwise revert to a previous, shallower compression depth) if, say, the condition subsides and/or is resolved by the deeper chest compressions administered after 710. Accordingly, the process 700 may iterate by outputting feedback to the rescuer 204 to decrease the compression depth in between successive iterations of the blocks 702-710, where the feedback to decrease the compression depth may be provided based on a determination that the subject 104 no longer has the condition (e.g., PEA, refractory VF, recurrent VF, asystole, etc.).

FIG. 8 illustrates an example of an external defibrillator 800 configured to perform various functions described herein. For example, the external defibrillator 800 is the defibrillator 208 described above with reference to FIG. 2.

The external defibrillator 800 includes an electrocardiogram (ECG) port 802 connected to multiple ECG wires 804. In some cases, the ECG wires 804 are removeable from the ECG port 802. For instance, the ECG wires 804 are plugged into the ECG port 802 via connectors. The ECG wires 804 are connected to ECG electrodes 806, respectively. In various implementations, the ECG electrodes 806 are disposed on different locations on an individual 808. For example, the individual 808 is the subject 104 described above. A detection circuit 810 is configured to detect relative voltages between the ECG electrodes 806. These voltages are indicative of the electrical activity of the heart of the individual 808.

In various implementations, the ECG electrodes 806 are in contact with the different locations on the skin of the individual 808. In some examples, a first one of the ECG electrodes 806 is placed on the skin between the heart and right arm of the individual 808, a second one of the ECG electrodes 806 is placed on the skin between the heart and left arm of the individual 808, and a third one of the ECG electrodes 806 is placed on the skin between the heart and a leg (either the left leg or the right leg) of the individual 808. In these examples, the detection circuit 810 is configured to measure the relative voltages between the first, second, and third ECG electrodes 806. Respective pairings of the ECG electrodes 806 are referred to as “leads,” and the voltages between the pairs of ECG electrodes 806 are known as “lead voltages.” In some examples, more than three ECG electrodes 806 are included, such that 5-lead or 12-lead ECG signals are detected by the detection circuit 810.

The detection circuit 810 includes at least one analog circuit, at least one digital circuit, or a combination thereof. The detection circuit 810 receives the analog electrical signals from the ECG electrodes 806, via the ECG port 802 and the ECG wires 804. In some cases, the detection circuit 810 includes one or more analog filters configured to filter noise and/or artifact from the electrical signals. The detection circuit 810 includes an analog-to-digital converter (ADC) in various examples. The detection circuit 810 generates a digital signal indicative of the analog electrical signals from the ECG electrodes 806. This digital signal can be referred to as an “ECG signal” or an “ECG.”

In some cases, the detection circuit 810 further detects an electrical impedance between at least one pair of the ECG electrodes 806. For example, the detection circuit 810 includes, or otherwise controls, a power source that applies a known voltage (or current) across a pair of the ECG electrodes 806 and detects a resultant current (or voltage) between the pair of the ECG electrodes 806. In various cases, the current is applied via a high-frequency (e.g., 20 kHz) carrier signal. The impedance is generated based on the applied signal (voltage or current) and the resultant signal (current or voltage). In various cases, the impedance corresponds to respiration of the individual 808, chest compressions performed on the individual 808, and other physiological states of the individual 808. In various examples, the detection circuit 810 includes one or more analog filters configured to filter noise and/or artifact from the resultant signal. The detection circuit 810 generates a digital signal indicative of the impedance using an ADC. This digital signal can be referred to as an “impedance signal” or an “impedance.”

The detection circuit 810 provides the ECG signal and/or the impedance signal one or more processors 812 in the external defibrillator 800. In some implementations, the processor(s) 812 includes a central processing unit (CPU), a graphics processing unit (GPU), both CPU and GPU, or other processing unit or component known in the art.

The processor(s) 812 is operably connected to memory 814. In various implementations, the memory 814 is volatile (such as random access memory (RAM)), non-volatile (such as read only memory (ROM), flash memory, etc.) or some combination of the two. The memory 814 stores instructions that, when executed by the processor(s) 812, causes the processor(s) 812 to perform various operations. In various examples, the memory 814 stores methods, threads, processes, applications, objects, modules, any other sort of executable instruction, or a combination thereof. In some cases, the memory 814 stores files, databases, or a combination thereof. In some examples, the memory 814 includes, but is not limited to, RAM, ROM, electrically erasable programmable read-only memory (EEPROM), flash memory, or any other memory technology. In some examples, the memory 814 includes one or more of compact disc-ROMs (CD-ROMs), digital versatile discs (DVDs), content-addressable memory (CAM), or other optical storage, magnetic cassettes, magnetic tape, magnetic disk storage or other magnetic storage devices, or any other medium which can be used to store the desired information and which can be accessed by the processor(s) 812 and/or the external defibrillator 800. In some cases, the memory 814 at least temporarily stores the ECG signal and/or the impedance signal.

In various examples, the memory 814 includes a detector 816, which causes the processor(s) 812 to determine, based on the ECG signal and/or the impedance signal, whether the individual 808 is exhibiting a particular heart rhythm. For instance, the processor(s) 812 determines whether the individual 808 is experiencing a shockable rhythm that is treatable by defibrillation. Examples of shockable rhythms include ventricular fibrillation (VF) and ventricular tachycardia (V-Tach). In some examples, the processor(s) 812 determines whether any of a variety of different rhythms (e.g., asystole, sinus rhythm, atrial fibrillation (AF), etc.) are present in the ECG signal.

The processor(s) 812 is operably connected to one or more input devices 818 and one or more output devices 820. Collectively, the input device(s) 818 and the output device(s) 820 function as an interface between a user and the defibrillator 800. The input device(s) 818 is configured to receive an input from a user and includes at least one of a keypad, a cursor control, a touch-sensitive display, a voice input device (e.g., a microphone), a haptic feedback device (e.g., a gyroscope), or any combination thereof. The output device(s) 820 includes at least one of a display, a speaker, a haptic output device, a printer, or any combination thereof. In various examples, the processor(s) 812 causes a display among the output device(s) 820 to visually output a waveform of the ECG signal and/or the impedance signal. In some implementations, the input device(s) 818 includes one or more touch sensors, the output device(s) 820 includes a display screen, and the touch sensor(s) are integrated with the display screen. Thus, in some cases, the external defibrillator 800 includes a touchscreen configured to receive user input signal(s) and visually output physiological parameters, such as the ECG signal and/or the impedance signal.

In some examples, the memory 814 includes an advisor 822, which, when executed by the processor(s) 812, causes the processor(s) 812 to generate advice and/or control the output device(s) 820 to output the advice to a user (e.g., a rescuer). In some examples, the processor(s) 812 provides, or causes the output device(s) 820 to provide, an instruction to perform CPR on the individual 808. In some cases, the processor(s) 812 evaluates, based on the ECG signal, the impedance signal, or other physiological parameters, CPR being performed on the individual 808 and causes the output device(s) 820 to provide feedback about the CPR in the instruction. According to some examples, the processor(s) 812, upon identifying that a shockable rhythm is present in the ECG signal, causes the output device(s) 820 to output an instruction and/or recommendation to administer a defibrillation shock to the individual 808.

The memory 814 also includes an initiator 824 which, when executed by the processor(s) 812, causes the processor(s) 812 to control other elements of the external defibrillator 800 in order to administer a defibrillation shock to the individual 808. In some examples, the processor(s) 812 executing the initiator 824 selectively causes the administration of the defibrillation shock based on determining that the individual 808 is exhibiting the shockable rhythm and/or based on an input from a user (received, e.g., by the input device(s) 818). In some cases, the processor(s) 812 causes the defibrillation shock to be output at a particular time, which is determined by the processor(s) 812 based on the ECG signal and/or the impedance signal.

In various cases, the memory 814 includes a compression depth component 827 that, when executed by the processor(s) 812, causes the defibrillator 800 to pair with and/or authenticate the CPR feedback device 206 and/or the rescuer device 212 of FIG. 2, determines that a subject (e.g., the individual 808) has a condition that may benefit from deeper chest compressions (e.g., PEA, refractory VF, recurrent VF, asystole, etc.), determines, by analyzing a parameter(s) associated with the subject (e.g., the individual 808) and sensed by a sensor(s), that a rescuer is manually administering chest compressions to the subject (e.g., the individual 808) at a first compression depth, and, in response to determining that the subject (e.g., the individual 808) has the condition (e.g., PEA, refractory VF, recurrent VF, asystole, etc.) and in response to determining that the first compression depth is less than a target compression depth for treating the condition (e.g., PEA, refractory VF, recurrent VF, asystole, etc.), causes a signal(s) to be output as feedback for the rescuer to administer future chest compressions to the subject (e.g., the individual 808) at the target compression depth, and/or causes performance of the techniques and/or processes described herein, such as the process 700, and/or any other technique or process described herein.

The processor(s) 812 is operably connected to a charging circuit 823 and a discharge circuit 825. In various implementations, the charging circuit 823 includes a power source 826, one or more charging switches 828, and one or more capacitors 830. The power source 826 includes, for instance, a battery. The processor(s) 812 initiates a defibrillation shock by causing the power source 826 to charge at least one capacitor among the capacitor(s) 830. For example, the processor(s) 812 activates at least one of the charging switch(es) 828 in the charging circuit 823 to complete a first circuit connecting the power source 826 and the capacitor to be charged. Then, the processor(s) 812 causes the discharge circuit 825 to discharge energy stored in the charged capacitor across a pair of defibrillation electrodes 834, which are in contact with the individual 808. For example, the processor(s) 812 deactivates the charging switch(es) 828 completing the first circuit between the capacitor(s) 830 and the power source 826, and activates one or more discharge switches 832 completing a second circuit connecting the charged capacitor 830 and at least a portion of the individual 808 disposed between defibrillation electrodes 834. In various cases, more than two defibrillation electrodes 834 are disposed on the skin of the individual 808, which define multiple shock vectors.

The energy is discharged from the defibrillation electrodes 834 in the form of a defibrillation shock. For example, the defibrillation electrodes 834 are connected to the skin of the individual 808 and located at positions on different sides of the heart of the individual 808, such that the defibrillation shock is applied across the heart of the individual 808. The defibrillation shock, in various examples, depolarizes a significant number of heart cells in a short amount of time. The defibrillation shock, for example, interrupts the propagation of the shockable rhythm (e.g., VF or VT) through the heart. In some examples, the defibrillation shock is 200 J or greater with a duration of about 0.015 seconds. In some cases, the defibrillation shock has a multiphasic (e.g., biphasic) waveform. The discharge switch(es) 832 are controlled by the processor(s) 812, for example. In various implementations, the defibrillation electrodes 834 are connected to defibrillation wires 836. The defibrillation wires 836 are connected to a defibrillation port 838, in implementations. According to various examples, the defibrillation wires 836 are removable from the defibrillation port 838. For example, the defibrillation wires 836 are plugged into the defibrillation port 838.

In various implementations, the processor(s) 812 is operably connected to one or more transceivers 840 that transmit and/or receive data over one or more communication networks 842. For example, the transceiver(s) 840 includes a network interface card (NIC), a network adapter, a local area network (LAN) adapter, or a physical, virtual, or logical address to connect to the various external devices and/or systems. In various examples, the transceiver(s) 840 includes any sort of wireless transceivers capable of engaging in wireless communication (e.g., radio frequency (RF) communication). For example, the communication network(s) 842 includes one or more wireless networks that include a 3^{rd} Generation Partnership Project (3GPP) network, such as a Long Term Evolution (LTE) radio access network (RAN) (e.g., over one or more LTE bands), a New Radio (NR) RAN (e.g., over one or more NR bands), or a combination thereof. In some cases, the transceiver(s) 840 includes other wireless modems, such as a modem for engaging in WI-FI®, WIGIG®, WIMAX®, BLUETOOTH®, or infrared communication over the communication network(s) 842.

The defibrillator 800 is configured to transmit and/or receive data (e.g., ECG data, impedance data, data indicative of one or more detected heart rhythms of the individual 808, data indicative of one or more defibrillation shocks administered to the individual 808, data associated with CPR treatment the individual 808 is receiving, etc.) with one or more external devices 844 via the communication network(s) 842. The external devices 844 include, for instance, mobile devices (e.g., mobile phones, smart watches, etc.), Internet of Things (IoT) devices, medical devices, computers (e.g., laptop devices, servers, etc.), or any other type of computing device configured to communicate over the communication network(s) 842. In some examples, the external device(s) 844 is located remotely from the defibrillator 800, such as at a remote clinical environment (e.g., a hospital). According to various implementations, the processor(s) 812 causes the transceiver(s) 840 to transmit data to the external device(s) 844. In some cases, the transceiver(s) 840 receives data from the external device(s) 844 and the transceiver(s) 840 provide the received data to the processor(s) 812 for further analysis.

In various implementations, the external defibrillator 800 also includes a housing 846 that at least partially encloses other elements of the external defibrillator 800. For example, the housing 846 encloses the detection circuit 810, the processor(s) 812, the memory 814, the charging circuit 823, the transceiver(s) 840, or any combination thereof. In some cases, the input device(s) 818 and output device(s) 820 extend from an interior space at least partially surrounded by the housing 846 through a wall of the housing 846. In various examples, the housing 846 acts as a barrier to moisture, electrical interference, and/or dust, thereby protecting various components in the external defibrillator 800 from damage.

In some implementations, the external defibrillator 800 is an automated external defibrillator (AED) operated by an untrained user (e.g., a bystander, layperson, etc.) and can be operated in an automatic mode. In automatic mode, the processor(s) 812 automatically identifies a rhythm in the ECG signal, makes a decision whether to administer a defibrillation shock, charges the capacitor(s) 830, discharges the capacitor(s) 830, or any combination thereof. In some cases, the processor(s) 812 controls the output device(s) 820 to output (e.g., display) a simplified user interface to the untrained user. For example, the processor(s) 812 refrains from causing the output device(s) 820 to display a waveform of the ECG signal and/or the impedance signal to the untrained user, in order to simplify operation of the external defibrillator 800.

In some examples, the external defibrillator 800 is a monitor-defibrillator utilized by a trained user (e.g., a clinician, an emergency responder, etc.) and can be operated in a manual mode or the automatic mode. When the external defibrillator 800 operates in manual mode, the processor(s) 812 cause the output device(s) 820 to display a variety of information that may be relevant to the trained user, such as waveforms indicating the ECG data and/or impedance data, notifications about detected heart rhythms, and the like.

FIG. 9 illustrates a mechanical chest compression device 900 configured to perform various functions described herein. For example, the mechanical chest compression device 900 is the mechanical chest compression device 102 described in FIG. 1.

In various implementations, the mechanical chest compression device 900 includes a compressor 902 that is operatively coupled to a motor 904. For example, the compressor 902 is the chest compressing mechanism 108 described in FIG. 1. The compressor 902 physically administers a force to the chest of a subject 906 that compresses the chest of the subject 906. For example, the subject 906 is the subject 104 described in FIG. 1. In some examples, the compressor 902 includes at least one piston 905 that periodically moves between two or more positions (e.g., a compressed position and a release position) at a compression frequency. For example, when the piston 905 is positioned on the chest of the subject 906, the piston 905 compresses the chest when the piston 905 is moved into the compressed position. A suction cup 907 may be positioned on a tip of the piston 905, such that the suction cup 907 contacts the chest of the subject 906 during operation. In various cases, the compressor 902 includes a band (e.g., a load-distributing band) that periodically tightens to a first tension and loosens to a second tension at a compression frequency. For instance, when the band is disposed around the chest of the subject 906, the band compresses the chest when the band tightens.

The motor 904 is configured to convert electrical energy stored in a power source 908 into mechanical energy that moves and/or tightens the compressor 902, thereby causing the compressor 902 to administer the force to the chest of the subject 906. In various implementations, the power source 908 is portable. For instance, the power source 908 includes at least one rechargeable (e.g., lithium-ion) battery. In some cases, the power source 908 supplies electrical energy to one or more elements of the mechanical chest compression device 900 described herein.

In various cases, the mechanical chest compression device 900 includes a support 910 that is physically coupled to the compressor 902, such that the compressor 902 maintains a position relative to the subject 906 during operation. In some implementations, the support 910 is physically coupled to a backplate 912, cot, or other external structure with a fixed position relative to the subject 906. In some examples, the support 910 includes a pair of legs that are configured to connect to the backplate 912 at respective sides of the backplate 912. According to some cases, the support 910 is physically coupled to a portion of the subject 906, such as wrists of the subject 906.

The operation of the mechanical chest compression device 900 may be controlled by at least one processor 914. In various implementations, the motor 904 is communicatively coupled to the processor(s) 914. Specifically, the processor(s) 914 is configured to output a control signal to the motor 904 that causes the motor 904 to actuate the compressor 902. For instance, the motor 904 causes the compressor 902 to administer the compressions to the subject 906 based on the control signal. In some cases, the control signal indicates one or more treatment parameters (sometimes referred to herein as “chest compression parameters”) of the compressions. Examples of treatment parameters include a frequency, timing, depth, force, position, velocity, and acceleration of the compressor 902 administering the compressions. According to various cases, the control signal causes the motor 904 to cease compressions and/or to hold the compressor 902 in a fixed position for a hold period.

In various implementations, the mechanical chest compression device 900 includes at least one transceiver 916 configured to communicate with at least one external device 918 over one or more communication networks 920. Any communication network described herein can be included in the communication network(s) 920 illustrated in FIG. 9. The external device(s) 918, for example, includes at least one of a monitor-defibrillator, an AED, an ECMO device, a ventilation device, a patient monitor, a mobile phone, a server, or a computing device. In some implementations, the transceiver(s) 916 is configured to communicate with the external device(s) 918 by transmitting and/or receiving signals wirelessly. For example, the transceiver(s) 916 includes a NIC, a network adapter, a LAN adapter, or a physical, virtual, or logical address to connect to the various external devices and/or systems. In various examples, the transceiver(s) 916 includes any sort of wireless transceivers capable of engaging in wireless communication (e.g., RF communication). For example, the communication network(s) 920 includes one or more wireless networks that include a 3GPP network, such as an LTE RAN (e.g., over one or more LTE bands), an NR RAN (e.g., over one or more NR bands), or a combination thereof. In some cases, the transceiver(s) 916 includes other wireless modems, such as a modem for engaging in WI-FI®, WIGIG®, WIMAX®, BLUETOOTH®, or infrared communication over the communication network(s) 920. The signals, in various cases, encode data in the form of data packets, datagrams, or the like. In some cases, the signals are transmitted as compressions are being administered by the mechanical chest compression device 900 (e.g., for real-time feedback by the external device(s) 918), after compressions are administered by the mechanical chest compression device 900 (e.g., for post-event review at the external device 918), or a combination thereof.

In various cases, the processor(s) 914 generates the control signal based on data encoded in the signals received from the external device(s) 918. For instance, the signals include an instruction to initiate the compressions, and the processor(s) 914 instructs the motor 904 to begin actuating the compressor 902 in accordance with the signals.

In some cases, the mechanical chest compression device 900 includes at least one input device 922. In various examples, the input device(s) 922 is configured to receive an input signal from a user 924, who may be a rescuer treating the subject 906. Examples of the input device(s) 922 include, for instance, a keypad, a cursor control, a touch-sensitive display, a voice input device (e.g., a microphone), a haptic feedback device (e.g., a gyroscope), or any combination thereof. In various implementations, the processor(s) 914 generates the control signal based on the input signal. For instance, the processor(s) 914 generates the control signal to adjust a frequency of the compressions based on the mechanical chest compression device 900 detecting a selection by the user 924 of a user interface element displayed on a touchscreen or detecting the user 924 pressing a button integrated with an external housing of the mechanical chest compression device 900.

According to some examples, the input device(s) 922 include one or more sensors. The sensor(s), for example, is configured to detect a physiological parameter of the subject 906. In some implementations, the sensor(s) is configured to detect a state parameter of the mechanical chest compression device 900, such as a position of the compressor 902 with respect to the subject 906 or the backplate 912, a force administered by the compressor 902 on the subject 906, a force administered onto the backplate 912 by the body of the subject 906 during a compression, or the like. According to some implementations, the signals transmitted by the transceiver(s) 916 indicate the physiological parameter(s) and/or the state parameter(s). In some examples, the sensor(s) include an auscultation device(s)/sensor(s) (e.g., a microphone(s)) configured to capture an audible sound signal (e.g., an audible heart sound) during CPR. For instance, the sensor(s) are disposed on surfaces of the backplate 912, the compressor 902 (e.g., the distal end of the suction cup 907), or a combination thereof.

The mechanical chest compression device 900 further includes at least one output device 925, in various implementations. Examples of the output device(s) 925 include, for instance, least one of a display (e.g., a projector, an LED screen, etc.), a speaker, a haptic output device, a printer, a light emitting element(s) (LED), or any combination thereof. In some implementations, the output device(s) 925 include a screen configured to display various parameters detected by and/or reported to the mechanical chest compression device 900, a charge level of the power source 908, a timer indicating a time since compressions were initiated or paused, and other relevant information.

The mechanical chest compression device 900 further includes memory 926. In various implementations, the memory 926 is volatile (such as random access memory (RAM)), non-volatile (such as read only memory (ROM), flash memory, etc.) or some combination of the two. The memory 926 stores instructions that, when executed by the processor(s) 914, causes the processor(s) 914 to perform various operations. In various examples, the memory 926 stores methods, threads, processes, applications, objects, modules, any other sort of executable instruction, or a combination thereof. In some cases, the memory 926 stores files, databases, or a combination thereof. In some examples, the memory 926 includes, but is not limited to, RAM, ROM, EEPROM, flash memory, or any other memory technology. In some examples, the memory 926 includes one or more of CD-ROMs, DVDs, CAM, or other optical storage, magnetic cassettes, magnetic tape, magnetic disk storage or other magnetic storage devices, or any other medium which can be used to store the desired information. In various cases, the memory 926 stores instructions, programs, threads, objects, data, or any combination thereof, that cause the processor(s) 914 to perform various functions. In various cases, the memory 926 stores one or more parameters that are detected by the mechanical chest compression device 900 and/or reported to the mechanical chest compression device 900.

In various cases, the memory 926 includes a compression depth component 927 that, when executed by the processor(s) 914, receives an indication that the subject 906 has a condition that may benefit from deeper chest compressions (e.g., PEA, refractory VF, recurrent VF, asystole, etc.), and, in response to receiving the indication that the subject 906 has the condition (e.g., PEA, refractory VF, recurrent VF, asystole, etc.), causes the compressor 902 to increase a current target compression depth to an increased target compression depth at which future chest compressions are to be administered to the subject 906, and/or causes performance of the techniques and/or processes described herein, such as the process 500, the process 600, and/or any other technique or process described herein.

### EXAMPLE CLAUSES

1. A mechanical chest compression device for use in cardiopulmonary resuscitation (CPR) treatment of a subject, the mechanical chest compression device comprising: a chest compressing mechanism configured to be placed on a chest of the subject and to administer chest compressions to the subject by: repeatedly applying a force to the chest of the subject; and
releasing the force in between successive applications of the force; and a processor configured to: cause the mechanical chest compression device to operate in a first mode where the chest compressing mechanism administers the chest compressions at a first target compression depth; receive an indication that the subject has pulseless electrical activity (PEA), refractory ventricular fibrillation (VF), recurrent VF, or asystole; and in response to receiving the indication that the subject has the PEA, the refractory VF, the recurrent VF, or the asystole, cause the mechanical chest compression device to switch to operating in a second mode where the chest compressing mechanism administers the chest compressions at a second target compression depth greater than the first target compression depth.
2. The mechanical chest compression device of clause 1, wherein the second target compression depth is greater than 6 centimeters (cm).
3. The mechanical chest compression device of clause 1 or 2, wherein: the chest compressing mechanism comprises a piston; in the first mode, the processor is configured to cause the piston to move, during a compression phase of a first compression-decompression cycle, from a first position to a second position that represents the first target compression depth; and in the second mode, the processor is configured to cause the piston to move, during the compression phase of a second compression-decompression cycle, from the first position to a third position that represents the second target compression depth.
4. The mechanical chest compression device of any one of clauses 1 to 3, wherein: the indication is a first indication; the processor is further configured to receive a second indication that a size of the chest of the subject satisfies a threshold size; and the processor is configured to cause the mechanical chest compression device to switch to operating in the second mode further in response to receiving the second indication that the size of the chest of the subject satisfies the threshold size.
5. A mechanical chest compression device comprising: a chest compressing mechanism configured to be disposed on a chest of a subject and to administer chest compressions to the subject; and a processor configured to: receive an indication that the subject has pulseless electrical activity (PEA), refractory ventricular fibrillation (VF), recurrent VF, or asystole; and in response to receiving the indication that the subject has the PEA, the refractory VF, the recurrent VF, or the asystole, cause the chest compressing mechanism to increase a current target compression depth to an increased target compression depth at which future chest compressions are to be administered to the subject.
6. The mechanical chest compression device of clause 5, wherein the increased target compression depth is greater than 6 centimeters (cm).
7. The mechanical chest compression device of clause 5 or 6, wherein the indication is received from a monitor-defibrillator communicatively coupled with the mechanical chest compression device.
8. The mechanical chest compression device of any one of clauses 5 to 7, further comprising an input device configured to receive user input to change an operating mode of the mechanical chest compression device, wherein the indication is received in response to receiving the user input via the input device to change the operating mode to an enhanced compression mode.
9. The mechanical chest compression device of any one of clauses 5 to 8, further comprising an input device configured to receive user input to confirm that the subject has the PEA, the refractory VF, the recurrent VF, or the asystole, wherein the indication is received in response to receiving the user input via the input device confirming that the subject has the PEA, the refractory VF, the recurrent VF, or the asystole.
10. The mechanical chest compression device of clause 9, further comprising an output device configured to output a prompt for a rescuer to confirm that the subject has the PEA, the refractory VF, the recurrent VF, or the asystole, wherein the user input is received in response to outputting the prompt via the output device.
11. The mechanical chest compression device of any one of clauses 5 to 10, wherein: the indication is a first indication; the processor is further configured to receive a second indication that a size of the chest of the subject satisfies a threshold size; and the processor is configured to cause the chest compressing mechanism to increase the current target compression depth to the increased target compression depth further in response to receiving the second indication that the size of the chest of the subject satisfies the threshold size.
12. The mechanical chest compression device of clause 11, further comprising an ultra-wide band unit, wherein the second indication is received from the ultra-wide band unit.
13. The mechanical chest compression device of clause 11, wherein: the chest compressing mechanism comprises a piston; and the second indication is received based on a position of the piston at a time at which the mechanical chest compression device is activated with the piston disposed on the chest of the subject.
14. The mechanical chest compression device of clause 11, further comprising an input device configured to receive user input to confirm that the size of the chest of the subject satisfies the threshold size, wherein the second indication is received in response to receiving the user input via the input device confirming that the size of the chest of the subject satisfies the threshold size.
15. The mechanical chest compression device of clause 14, further comprising an output device configured to output a prompt for a rescuer to confirm that the size of the chest of the subject satisfies the threshold size, wherein the user input is received in response to outputting the prompt via the output device.
16. The mechanical chest compression device of clause 11, wherein: the size of the chest of the subject comprises a height of the chest of the subject; and the increased target compression depth is less than a threshold percentage of the height of the chest of the subject.
17. The mechanical chest compression device of any one of clauses 5 to 16, wherein: the chest compressing mechanism comprises a piston; and the processor is further configured to cause the piston to move, during a compression phase of a compression-decompression cycle, from a first position to a second position that represents the increased target compression depth.
18. A method comprising: causing, by a processor, a chest compressing mechanism of a mechanical chest compression device to administer first chest compressions to a subject at a first target compression depth; receiving, by the processor, an indication that the subject has pulseless electrical activity (PEA), refractory ventricular fibrillation (VF), recurrent VF, or asystole; and in response to receiving the indication that the subject has the PEA, the refractory VF, the recurrent VF, or the asystole, causing, by the processor, the chest compressing mechanism to administer second chest compressions to the subject at a second target compression depth greater than the first target compression depth.
19. The method of clause 18, wherein the second target compression depth is greater than 6 centimeters (cm).
20. The method of clause 18 or 19, wherein the indication is received from a monitor-defibrillator communicatively coupled with the mechanical chest compression device.
21. The method of any one of clauses 18 to 20, wherein the indication is received in response to receiving user input via an input device of the mechanical chest compression device to change an operating mode of the mechanical chest compression device to an enhanced compression mode.
22. The method of any one of clauses 18 to 21, wherein the indication is a first indication, the method further comprising: receiving, by the processor, a second indication that a size of a chest of the subject satisfies a threshold size, wherein causing the chest compressing mechanism to administer the second chest compressions to the subject at the second target compression depth is further in response to receiving the second indication that the size of the chest of the subject satisfies the threshold size.
23. A method comprising: causing, by a processor, a chest compressing mechanism of a mechanical chest compression device to administer first chest compressions to a subject at a first target compression depth; receiving, by the processor, an indication that the subject has a condition of a predefined set of one or more conditions; and in response to receiving the indication that the subject has the condition, causing, by the processor, the chest compressing mechanism to administer second chest compressions to the subject at a second target compression depth greater than the first target compression depth.
24. A cardiopulmonary resuscitation (CPR) feedback system comprising: a sensor configured to sense a chest compression depth parameter associated with a subject as a rescuer is manually administering chest compressions to the subject; and a processor configured to: determine, during administration of the chest compressions, that the subject has pulseless electrical activity (PEA), refractory ventricular fibrillation (VF), recurrent VF, or asystole; determine, by analyzing the chest compression depth parameter sensed by the sensor, that the rescuer is manually administering the chest compressions to the subject at a first compression depth that is insufficient to treat the PEA, the refractory VF, the recurrent VF, or the asystole; and in response to determining that the subject has the PEA, the refractory VF, the recurrent VF, or the asystole and in response to determining that the first compression depth is insufficient to treat the PEA, the refractory VF, the recurrent VF, or the asystole, cause a signal to be output as feedback for the rescuer to administer deeper chest compressions to the subject at a target compression depth for treating the PEA, the refractory VF, the recurrent VF, or the asystole.
25. The CPR feedback system of clause 24, wherein the target compression depth is greater than 6 centimeters (cm).
26. The CPR feedback system of clause 24 or 25, wherein: the processor is further configured to receive an indication that a size of a chest of the subject satisfies a threshold size; and the processor is configured to cause the signal to be output further in response to receiving the indication that the size of the chest of the subject satisfies the threshold size.
27. The CPR feedback system of any one of clauses 24 to 26, wherein the signal comprises an audible signal, a visual signal, or a haptic signal.
28. A cardiopulmonary resuscitation (CPR) feedback system comprising: a sensor configured to sense a parameter associated with a subject as a rescuer is manually administering chest compressions to the subject; and a processor configured to: determine that the subject has pulseless electrical activity (PEA), refractory ventricular fibrillation (VF), recurrent VF, or asystole;
determine, by analyzing the parameter sensed by the sensor, that the rescuer is manually administering the chest compressions to the subject at a first compression depth; and in response to determining that the subject has the PEA, the refractory VF, the recurrent VF, or the asystole and in response to determining that the first compression depth is less than a target compression depth for treating the PEA, the refractory VF, the recurrent VF, or the asystole, cause a signal to be output as feedback for the rescuer to administer future chest compressions to the subject at the target compression depth.
29. The CPR feedback system of clause 28, wherein the target compression depth is greater than 6 centimeters (cm).
30. The CPR feedback system of clause 28 or 29, wherein: the processor is a component of a monitor-defibrillator communicatively coupled with the sensor; the signal is output via an output device of the monitor-defibrillator; and the signal is an audible signal or a visual signal.
31. The CPR feedback system of any one of clauses 28 to 30, wherein: the processor is a component of a monitor-defibrillator communicatively coupled with the sensor; and the processor is configured to determine that the subject has the PEA, the refractory VF, the recurrent VF, or the asystole by analyzing a physiological parameter of the subject.
32. The CPR feedback system of any one of clauses 28 to 31, further comprising an input device configured to receive user input to confirm that the subject has the PEA, the refractory VF, the recurrent VF, or the asystole, wherein the processor is configured to determine that the subject has the PEA, the refractory VF, the recurrent VF, or the asystole in response to receiving the user input via the input device confirming that the subject has the PEA, the refractory VF, the recurrent VF, or the asystole.
33. The CPR feedback system of any one of clauses 28 to 32, wherein: the processor is further configured to receive an indication that a size of a chest of the subject satisfies a threshold size; and the processor is configured to cause the signal to be output further in response to receiving the indication that the size of the chest of the subject satisfies the threshold size.
34. The CPR feedback system of clause 33, wherein the indication is received from an ultra-wide band unit.
35. The CPR feedback system of clause 33, wherein the indication is received from an accelerometer disposed on the chest of the subject.
36. The CPR feedback system of clause 33, further comprising an input device configured to receive user input to confirm that the size of the chest of the subject satisfies the threshold size, wherein the indication is received in response to receiving the user input via the input device confirming that the size of the chest of the subject satisfies the threshold size.
37. The CPR feedback system of clause 36, further comprising an output device configured to output a prompt for the rescuer to confirm that the size of the chest of the subject satisfies the threshold size, wherein the user input is received in response to outputting the prompt via the output device.
38. The CPR feedback system of clause 33, wherein: the size of the chest of the subject comprises a height of the chest of the subject; the signal is a first signal; and the processor is further configured to: determine, after causing the first signal to be output, and by analyzing the parameter sensed by the sensor, that the rescuer is manually administering the chest compressions to the subject at a second compression depth; and in response to determining that the second compression depth is greater than a threshold percentage of the height of the chest of the subject, cause a second signal to be output as feedback for the rescuer indicating that the rescuer is compressing too deep.
39. The CPR feedback system of any one of clauses 28 to 38, wherein: the signal is a first signal; the chest compressions are first chest compressions administered at a first time; and the processor is further configured to: determine, by analyzing the parameter sensed by the sensor, that the rescuer is manually administering second chest compressions to the subject at the target compression depth; and in response to determining that the rescuer is manually administering the second chest compressions to the subject at the target compression depth, cause a second signal to be output as feedback for the rescuer indicating that the rescuer is administering CPR correctly.
40. The CPR feedback system of any one of clauses 28 to 39, wherein the signal comprises an audible signal, a visual signal, or a haptic signal.
41. A method comprising: determining, by a processor of a cardiopulmonary resuscitation (CPR) feedback system, that a subject has pulseless electrical activity (PEA), refractory ventricular fibrillation (VF), recurrent VF, or asystole; determining, by the processor, and by analyzing a parameter associated with the subject and sensed by a sensor, that a rescuer is manually administering chest compressions to the subject at a first compression depth; and in response to determining that the subject has the PEA, the refractory VF, the recurrent VF, or the asystole and in response to determining that the first compression depth is less than a target compression depth for treating the PEA, the refractory VF, the recurrent VF, or the asystole, causing, by the processor, a signal to be output as feedback for the rescuer to administer future chest compressions to the subject at the target compression depth.
42. The method of clause 41, wherein the target compression depth is greater than 6 centimeters (cm).
43. The method of clause 41 or 42, further comprising receiving, by the processor, an indication of user input received via an input device of the CPR feedback system, the user input confirming that the subject has the PEA, the refractory VF, the recurrent VF, or the asystole, wherein determining that the subject has the PEA, the refractory VF, the recurrent VF, or the asystole is in response to receiving the indication.
44. The method of any one of clauses 41 to 43, further comprising receiving, by the processor, an indication that a size of a chest of the subject satisfies a threshold size, wherein causing the signal to be output is further in response to receiving the indication.
45. The method of any one of clauses 41 to 44, wherein the signal comprises an audible signal, a visual signal, or a haptic signal.
46. A method comprising: determining, by a processor of a cardiopulmonary resuscitation (CPR) feedback system, that a subject has a condition of a predefined set of one or more conditions; determining, by the processor, and by analyzing a parameter associated with the subject and sensed by a sensor, that a rescuer is manually administering chest compressions to the subject at a first compression depth; and in response to determining that the subject has the condition and in response to determining that the first compression depth is less than a target compression depth for treating the condition, causing, by the processor, a signal to be output as feedback for the rescuer to administer future chest compressions to the subject at the target compression depth.

While the example clauses described above are described with respect to one particular implementation, it should be understood that, in the context of this document, the content of the example clauses can also be implemented via a method, device, system, computer-readable medium, and/or another implementation. Additionally, any one of examples 1-46 may be implemented alone or in combination with any other of the examples 1-46.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing implementations of the disclosure in diverse forms thereof.

As will be understood by one of ordinary skill in the art, each implementation disclosed herein can comprise, consist essentially of or consist of its particular stated element, step, or component. Thus, the terms “include” or “including” should be interpreted to recite: “comprise, consist of, or consist essentially of.” The transition term “comprise” or “comprises” means has, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the implementation to the specified elements, steps, ingredients or components and to those that do not materially affect the implementation. As used herein, the term “based on” is equivalent to “based at least partly on,” unless otherwise specified.

Unless otherwise indicated, all numbers expressing quantities, properties, conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing implementations (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate implementations of the disclosure and does not pose a limitation on the scope of the disclosure. No language in the specification should be construed as indicating any non-claimed element essential to the practice of implementations of the disclosure.

Groupings of alternative elements or implementations disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain implementations are described herein, including the best mode known to the inventors for carrying out implementations of the disclosure. Of course, variations on these described implementations will become apparent to those of ordinary skill in the art upon reading the foregoing description. The inventors expect skilled artisans to employ such variations as appropriate, and the inventors intend for implementations to be practiced otherwise than specifically described herein. Accordingly, the scope of this disclosure includes all modifications and equivalents of the subject matter recited in the claims appended hereto as permitted by applicable law. Moreover, any combination of the above-described elements in all possible variations thereof is encompassed by implementations of the disclosure unless otherwise indicated herein or otherwise clearly contradicted by context.

What is claimed is:

1. A mechanical chest compression device for use in cardiopulmonary resuscitation (CPR) treatment of a subject, the mechanical chest compression device comprising:
a chest compressing mechanism configured to be placed on a chest of the subject and to administer chest compressions to the subject by:
repeatedly applying a force to the chest of the subject; and
releasing the force in between successive applications of the force; and
a processor configured to:
cause the mechanical chest compression device to operate in a first mode where the chest compressing mechanism administers the chest compressions at a first target compression depth;
receive an indication that the subject has pulseless electrical activity (PEA), refractory ventricular fibrillation (VF), recurrent VF, or asystole; and
in response to receiving the indication that the subject has the PEA, the refractory VF, the recurrent VF, or the asystole, cause the mechanical chest compression device to switch to operating in a second mode where the chest compressing mechanism administers the chest compressions at a second target compression depth greater than the first target compression depth.

2. The mechanical chest compression device of claim 1, wherein the second target compression depth is greater than 6 centimeters (cm).

3. The mechanical chest compression device of claim 1, wherein:
the chest compressing mechanism comprises a piston;
in the first mode, the processor is configured to cause the piston to move, during a compression phase of a first compression-decompression cycle, from a first position to a second position that represents the first target compression depth; and
in the second mode, the processor is configured to cause the piston to move, during the compression phase of a second compression-decompression cycle, from the first position to a third position that represents the second target compression depth.

4. The mechanical chest compression device of claim 1, wherein:
the indication is a first indication;
the processor is further configured to receive a second indication that a size of the chest of the subject satisfies a threshold size; and
the processor is configured to cause the mechanical chest compression device to switch to operating in the second mode further in response to receiving the second indication that the size of the chest of the subject satisfies the threshold size.

5. A mechanical chest compression device comprising:
a chest compressing mechanism configured to be disposed on a chest of a subject and to administer chest compressions to the subject; and
a processor configured to:
receive an indication that the subject has pulseless electrical activity (PEA), refractory ventricular fibrillation (VF), recurrent VF, or asystole; and
in response to receiving the indication that the subject has the PEA, the refractory VF, the recurrent VF, or the asystole, cause the chest compressing mechanism to increase a current target compression depth to an increased target compression depth at which future chest compressions are to be administered to the subject.

6. The mechanical chest compression device of claim 5, wherein the increased target compression depth is greater than 6 centimeters (cm).

7. The mechanical chest compression device of claim 5, wherein the indication is received from a monitor-defibrillator communicatively coupled with the mechanical chest compression device.

8. The mechanical chest compression device of claim 5, further comprising an input device configured to receive user input to change an operating mode of the mechanical chest compression device, wherein the indication is received in response to receiving the user input via the input device to change the operating mode to an enhanced compression mode.

9. The mechanical chest compression device of claim 5, further comprising an input device configured to receive user input to confirm that the subject has the PEA, the refractory VF, the recurrent VF, or the asystole, wherein the indication is received in response to receiving the user input via the input device confirming that the subject has the PEA, the refractory VF, the recurrent VF, or the asystole.

10. The mechanical chest compression device of claim 9, further comprising an output device configured to output a prompt for a rescuer to confirm that the subject has the PEA, the refractory VF, the recurrent VF, or the asystole, wherein the user input is received in response to outputting the prompt via the output device.

11. The mechanical chest compression device of claim 5, wherein:
the indication is a first indication;
the processor is further configured to receive a second indication that a size of the chest of the subject satisfies a threshold size; and
the processor is configured to cause the chest compressing mechanism to increase the current target compression depth to the increased target compression depth further in response to receiving the second indication that the size of the chest of the subject satisfies the threshold size.

12. The mechanical chest compression device of claim 11, further comprising an ultra-wide band unit, wherein the second indication is received from the ultra-wide band unit.

13. The mechanical chest compression device of claim 11, wherein:
the chest compressing mechanism comprises a piston; and
the second indication is received based on a position of the piston at a time at which the mechanical chest compression device is activated with the piston disposed on the chest of the subject.

14. The mechanical chest compression device of claim 11, further comprising an input device configured to receive user input to confirm that the size of the chest of the subject satisfies the threshold size, wherein the second indication is received in response to receiving the user input via the input device confirming that the size of the chest of the subject satisfies the threshold size.

15. The mechanical chest compression device of claim 11, wherein:
the size of the chest of the subject comprises a height of the chest of the subject; and
the increased target compression depth is less than a threshold percentage of the height of the chest of the subject.

16. A method comprising:
causing, by a processor, a chest compressing mechanism of a mechanical chest compression device to administer first chest compressions to a subject at a first target compression depth;
receiving, by the processor, an indication that the subject has pulseless electrical activity (PEA), refractory ventricular fibrillation (VF), recurrent VF, or asystole; and
in response to receiving the indication that the subject has the PEA, the refractory VF, the recurrent VF, or the asystole, causing, by the processor, the chest compressing mechanism to administer second chest compressions to the subject at a second target compression depth greater than the first target compression depth.

17. The method of claim 16, wherein the second target compression depth is greater than 6 centimeters (cm).

18. The method of claim 16, wherein the indication is received from a monitor-defibrillator communicatively coupled with the mechanical chest compression device.

19. The method of claim 16, wherein the indication is received in response to receiving user input via an input device of the mechanical chest compression device to change an operating mode of the mechanical chest compression device to an enhanced compression mode.

20. The method of claim 16, wherein the indication is a first indication, the method further comprising:
receiving, by the processor, a second indication that a size of a chest of the subject satisfies a threshold size,
wherein causing the chest compressing mechanism to administer the second chest compressions to the subject at the second target compression depth is further in response to receiving the second indication that the size of the chest of the subject satisfies the threshold size.
